(19) United States
(12) Patent Application Publication
(10) Pub. No.: US 2011/0243481 A1
(43) Pub. Date: Oct. 6, 2011

(54) PACKAGING BAG WITH ZIPPER TAPE, DEVICE AND METHOD FOR MANUFACTURING PACKAGING BAG, AND BAND-LIKE MEMBER FOR BENDING

(76) Inventor: Shuichi Goto, Chuo-ku (JP)

(21) Appl. No.: 13/133,739

(22) PCT Filed: Dec. 8, 2009
(86) PCT No.: PCT/JP2009/070527

§ 371 Date: Jun. 9, 2011

(30) Foreign Application Priority Data
Dec. 9, 2008 (JP) 2008-313073
Dec. 9, 2008 (JP) 2008-313074

(51) Int. Cl. B65D 33/16; B31B 39/00; B32B 7/12

(52) U.S. Cl. 383/63; 493/210; 428/343

(57) ABSTRACT

A packaging bag includes a male belt-like base edge and a female belt-like base edge which are abutted on each other. Accordingly, a base material film is bent between the male belt-like base edge and the female belt-like base edge, thereby reliably engaging a male engagement portion with a female engagement portion. According to a manufacturing device of the packaging bag, since a male belt-like member and a female belt-like member are bonded to a sheet of base material tape while the male belt-like base edge and the female belt-like base edge are substantially abutted on each other by first and second grooves, an adhesion operation can be conducted with accuracy.

### TECHNICAL FIELD

The present invention relates to a packaging bag with a zipper tape, a device and a method for manufacturing the packaging bag, and a belt-like member for bending (hereinafter, referred to as a bendable belt-like member).

### BACKGROUND ART

A packaging bag with a zipper tape has been used in many fields such as foods, medical products and groceries. A zipper tape provided by a male belt-like member and a female belt-like member at an opening portion of a packaging bag has been known (see Patent Literatures 1 and 2).

Patent Literature 1 discloses a method and a device for manufacturing a bag with a zipper by using a rotary drum mechanism. In the manufacturing method, it is disclosed that each of a male member and a female member is attached to a single strip of tape.

Patent Literature 2 discloses a seal device for a zipper tape that attaches a male member and a female member to different base material films.

### CITATION LIST

### Patent Literatures

Patent Literature 1: Japanese Patent No. 3640437

Patent Literature 2: JP-UM-A-3-36825

### SUMMARY OF THE INVENTION

### Problems to be Solved by the Invention

In the arrangements as disclosed in Patent Literatures 1 and 2, when a male member and a female member are attached to a sheet of base material film forming a packaging bag, it may be difficult that the male member and the female member are attached thereto while being accurately positioned simultaneously. When such a positioning is not accurate, the male member and the female member may not be accurately engaged.

An object of the invention is to provide a packaging bag with a zipper tape in which a male belt-like member and a female belt-like member are accurately engageable with each other, a device and a method for manufacturing the packaging bag, and a bendable belt-like member.

### MEANS FOR SOLVING THE PROBLEMS

A packaging bag with a zipper tape according to an aspect of the invention includes: a male belt-like member having a male engagement portion; a female belt-like member having a female engagement portion; a sheet of base material film on which the male belt-like member and the female belt-like member are provided; and an engagement positioning unit that enables the male engagement portion and the female engagement portion to be engaged with each other when the base material film is bent, the engagement positioning unit being positioned substantially at the same distance from the male engagement portion and the female engagement portion.

In the packaging bag with the zipper tape according to the above aspect of the invention, the engagement positioning unit is preferably provided with a male-side abutment portion and a female-side abutment portion respectively in the male belt-like member and the female belt-like member, the male-side abutment portion and the female-side abutment portion abutting on each other at ends thereof in a width direction.

In the packaging bag with the zipper tape according to the above aspect of the invention, the engagement positioning unit is also preferably a bendable belt-like member provided between the male belt-like member and the female belt-like member and including a bent portion that enables the base material film to be bent, the bent portion positioned substantially at the same distance from the male engagement portion and the female engagement portion.

In the packaging bag with the zipper tape, preferably, the male belt-like member has a cuttable male thin portion, and the female belt-like member has a cuttable female thin portion.

With this arrangement, the male thin portion and the female thin portion each may be positioned at different distances from the engagement positioning unit.

A packaging bag with a zipper tape according to another aspect of the invention includes: a male belt-like member having a male engagement portion; a female belt-like member having a female engagement portion; a sheet of base material film on which the male belt-like member and the female belt-like member are provided; and a bendable belt-like member provided between the male belt-like member and the female belt-like member on the base material film, in which the bendable belt-like member has a bent portion positioned substantially at the same distance from the male engagement portion and the female engagement portion.

In the above aspect of the invention, the male engagement portion and the female engagement portion can be accurately engaged with each other by bending the bent portion.

With this arrangement, the bent portion in the packaging bag with the zipper tape may be provided at the substantial center of the bendable belt-like member in a width direction.

Moreover, with this arrangement, the bent portion in the packaging bag with the zipper tape may be provided close to either edge of the bendable belt-like member apart from the substantial center thereof in a width direction.

In the packaging bag with the zipper tape according to the above aspect of the invention, preferably, an edge of the male belt-like member and an edge of the female belt-like member are respectively spaced from edges of the bendable belt-like member with a predetermined gap.

With this arrangement, the gap between the male belt-like member and the bendable belt-like member may be the same as or different from the gap between the female belt-like member and the bendable belt-like member. When the gaps are the same, each of the gaps is preferably in a range of 0.5 mm to 30 mm. When the gaps are different, one of the gaps is preferably in a range of 0.5 mm to 10 mm and the other of the gaps is preferably in a range of 3 mm to 30 mm.

A linear cutting and a cutting at different levels become achievable by adjusting: a position of the bent portion of the bendable belt-like member; a gap between the edge of the male belt-like member and the edge of the bendable belt-like member; and a gap between the edge of the female belt-like member and the edge of the bendable belt-like member.

For instance, a linear cutting becomes possible when the position of the bent portion is at the substantial center of the bendable belt-like member in a width direction, and the gap between the edge of the male belt-like member and the edge of the bendable belt-like member is the same as the gap between the edge of the female belt-like member and the edge of the bendable belt-like member. A cutting at different levels becomes possible when the position of the bent portion is at the substantial center of the bendable belt-like member in a width direction and the gap between the edge of the male belt-like member and the edge of the bendable belt-like member is different from the gap between the edge of the female belt-like member and the edge of the bendable belt-like member, or when the position of the bent portion is close to an either end of the bendable belt-like member apart from the substantial center thereof in a width direction.

In the packaging bag with the zipper tape according to the above aspect of the invention, preferably, each of the male belt-like member and the female belt-like member is substantially abutted on the bendable belt-like member and has a thin portion.

It is preferable that the bendable belt-like member has a width of 5 mm to 200 mm.

It is preferable that each of the male belt-like member and the female belt-like member has a width of 2 mm to 50 mm.

In a manufacturing device of a packaging bag with a zipper tape according to still another aspect of the invention, the packaging bag including: a male belt-like member having a male engagement portion; a female belt-like member having a female engagement portion; and a sheet of base material film on which the male belt-like member and the female belt-like member are provided, the manufacturing device includes: a substantially cylindrical rotary drum provided with a first groove that introduces the male engagement portion and a second groove that introduces the female engagement portion, the first and second groove being provided along a circumferential direction of the rotary drum; and a seal bar having a temperature adjusting mechanism on a heating surface curved to conform with a periphery of the rotary drum, in which the first and second grooves are allowed to respectively introduce the male engagement portion and the female engagement portion while the male belt-like member and the female belt-like member are substantially abutted on each other at ends thereof in a width direction.

In the manufacturing device of the packaging bag with the zipper tape according to the above aspect of the invention, the first and second grooves are allowed to respectively introduce the male engagement portion and the female engagement portion while a bendable belt-like member that enables the male engagement portion and the female engagement portion to be engaged with each other is provided between the male belt-like member and the female belt-like member and is substantially abutted thereon.

In a manufacturing device of a packaging bag with a zipper tape according to a further aspect of the invention, the packaging bag including: a male belt-like member having a male engagement portion; a female belt-like member having a female engagement portion; and a sheet of base material film on which the male belt-like member and the female belt-like member are provided, the manufacturing device includes: a substantially cylindrical rotary drum provided with a first groove that introduces the male engagement portion and a second groove that introduces the female engagement portion, the first and second groove being provided along a circumferential direction of the rotary drum; and a seal bar having a temperature adjusting mechanism on a heating surface curved to conform with a periphery of the rotary drum, in which a third groove is provided between the first groove and the second groove on an outer periphery of the rotary drum and introduces a bendable belt-like member that enables the male engagement portion and the female engagement portion to be engaged with each other.

In a manufacturing method of a packaging bag with a zipper tape according to a still further aspect of the invention, the packaging bag including: a male belt-like member having a male engagement portion; a female belt-like member having a female engagement portion; and a sheet of base material film on which the male belt-like member and the female belt-like member are provided, the manufacturing method includes: while the male belt-like member and the female belt-like member are abutted on each other at ends thereof in a width direction and the male engagement portion and the female engagement portion are engageable with each other, introducing the male engagement portion and the female engagement portion respectively into a first groove and a second groove formed along a circumferential direction of a rotary drum; and bonding the male belt-like member and the female belt-like member to the base material film by pressing the base material film with a seal bar having a temperature adjusting mechanism on a heating surface curved to conform with a periphery of the rotary drum while continuously moving the base material film along the circumferential direction of the rotary drum.

In a manufacturing method of a packaging bag with a zipper tape according to a still further aspect of the invention, the packaging bag including: a male belt-like member having a male engagement portion; a female belt-like member having a female engagement portion; and a sheet of base material film on which the male belt-like member and the female belt-like member are provided, the manufacturing method includes: while ends of a bendable belt-like member having a bent portion are respectively spaced from an end of the male belt-like member and an end of the female belt-like member in each width direction thereof with a predetermined gap, the bendable belt-like member provided between the male belt-like member and the female belt-like member and enabling the male engagement portion and the female engagement portion to be engaged with each other, introducing the male engagement portion and the female engagement portion respectively into a first groove and a second groove formed along a circumferential direction of a rotary drum; and bonding the male belt-like member, the female belt-like member and the bendable belt-like member on the base material film by pressing the base material film with a seal bar having a temperature adjusting mechanism on a heating surface curved to conform with a periphery of the rotary drum while continuously moving the base material film along the circumferential direction of the rotary drum.

In a manufacturing method of a packaging bag with a zipper tape according to a still further aspect of the invention, the packaging bag including: a male belt-like member having a male engagement portion; a female belt-like member having a female engagement portion; and a sheet of base material film on which the male belt-like member and the female belt-like member are provided, the manufacturing method includes: while ends of a bendable belt-like member having a bent portion are respectively spaced from an end of the male belt-like member and an end of the female belt-like member in each width direction thereof with a predetermined gap, the bendable belt-like member provided between the male belt-like member and the female belt-like member and enabling the male engagement portion and the female engagement portion to be engaged with each other, introducing the male engagement portion and the female engagement portion respectively into a first groove and a second groove formed along a circumferential direction of a rotary drum and the bendable belt-like member into a third groove formed along the circumferential direction of the rotary drum between the first and second grooves, and bonding the male belt-like member, the female belt-like member and the bendable belt-like member to the base material film by pressing the base material film with a seal bar having a temperature adjusting mechanism on a heating surface curved to conform with a periphery of the rotary drum while continuously moving the base material film along the circumferential direction of the rotary drum.

In a manufacturing method of a packaging bag with a zipper tape according to a still further aspect of the invention, the packaging bag including: a male belt-like member having a male engagement portion; a female belt-like member having a female engagement portion; and a sheet of base material film on which the male belt-like member and the female belt-like member are provided, the manufacturing method includes: while the male engagement portion, the female engagement portion and the bendable belt-like member are respectively introduced to first, second and third grooves formed along a circumferential direction of a rotary drum, bonding the male belt-like member, the female belt-like member and the bendable belt-like member to the base material film by pressing the base material film with a seal bar having a heating surface curved to conform with a periphery of the rotary drum while continuously moving the base material film along the circumferential direction of the rotary drum.

A bendable belt-like member according to a still further aspect of the invention enables a base material film to be bent for engaging a male engagement portion with a female engagement portion provided on a sheet of base material tape, and the bendable belt-like member includes: a bent portion centered on the bendable belt-like member in a width direction thereof; and an adhesion surface to which the base material tape is to be bonded.

A bendable belt-like member according to a still further aspect of the invention enables a base material film to be bent for engaging a male engagement portion with a female engagement portion provided on a sheet of base material tape, and the bendable belt-like member includes: a bent portion provided close to either edge of the bendable belt-like member from the center thereof in a width direction, and an adhesion surface to which the base material tape is to be bonded.

In the bendable belt-like member according to the above aspect of the invention, the bent portion is preferably a cutout portion or a thin portion.

The above aspects of the invention can provide the packaging bag with the zipper tape in which the male engagement portion and the female engagement portion are accurately engageable with each other, the device and the method for manufacturing the packaging bag with the zipper tape, and the bendable belt-like member.

### BRIEF DESCRIPTION OF DRAWINGS

FIG. 1 is a front view showing a packaging bag according to a first exemplary embodiment.

FIG. 2 is a cross sectional view showing the packaging bag according to the first exemplary embodiment.

FIG. 3 is a perspective view showing a manufacturing device of the packaging bag according to the first exemplary embodiment.

FIG. 4 is a cross sectional view showing a state where a zipper tape 20 is heat-sealed to a base material film in a manufacturing method of the packaging bag according to the first exemplary embodiment.

FIG. 5 is a cross sectional view showing a state where a male belt-like member and a female belt-like member of the zipper tape 20 are melt-flattened in the manufacturing method of the packaging bag according to the first exemplary embodiment.

FIG. 6 is a perspective view showing a state where a gusset is formed in the packaging bag in a manufacturing method of the packaging bag according to any one of the first exemplary embodiment and a sixth exemplary embodiment.

FIG. 7 is a cross sectional view showing a packaging bag according to a second exemplary embodiment.

FIG. 8 is a cross sectional view showing a packaging bag according to a third exemplary embodiment.

FIG. 9 is a cross sectional view showing a packaging bag according to a fourth exemplary embodiment.

FIG. 10 is a cross sectional view showing a state where a zipper tape 20 is heat-sealed to a base material film in a manufacturing method of the packaging bag according to the fourth exemplary embodiment.

FIG. 11 is a cross sectional view showing a packaging bag according to a fifth exemplary embodiment.

FIG. 12 is a front view showing a packaging bag according to a sixth exemplary embodiment.

FIG. 13 is a cross sectional view showing the packaging bag according to the sixth exemplary embodiment.

FIG. 14 is a perspective view showing a manufacturing device of the packaging bag according to the sixth exemplary embodiment.

FIG. 15 is a cross sectional view showing a state where a zipper tape is heat-sealed to a base material film in a manufacturing method of the packaging bag according to the sixth exemplary embodiment.

FIG. 16 is a cross sectional view showing a state where a male belt-like member and a female belt-like member of the zipper tape are melt-flattened in the manufacturing method of the packaging bag according to the sixth exemplary embodiment.

FIG. 17 is a cross sectional view showing a packaging bag according to a seventh exemplary embodiment.

FIG. 18 is a cross sectional view showing a state where the packaging bag according to the seventh exemplary embodiment is opened.

FIG. 19 is a cross sectional view showing a packaging bag according to another exemplary embodiment.

FIG. 20 is a cross sectional view showing a packaging bag according to still another exemplary embodiment.

FIG. 21 is a cross sectional view showing a state where a zipper tape is heat-sealed to a base material film in a manufacturing method of the packaging bag according to the still another exemplary embodiment.

### DESCRIPTION OF EXEMPLARY EMBODIMENTS

Exemplary embodiments of the invention will be described below with reference to the attached drawings.

In the exemplary embodiments, a packaging bag with a zipper tape (hereinafter, abbreviated as a “packaging bag”) is exemplified by a packaging bag for packaging various articles such as foods, medicines, medical products and groceries.

### First Exemplary Embodiment

### Arrangement of Packaging Bag

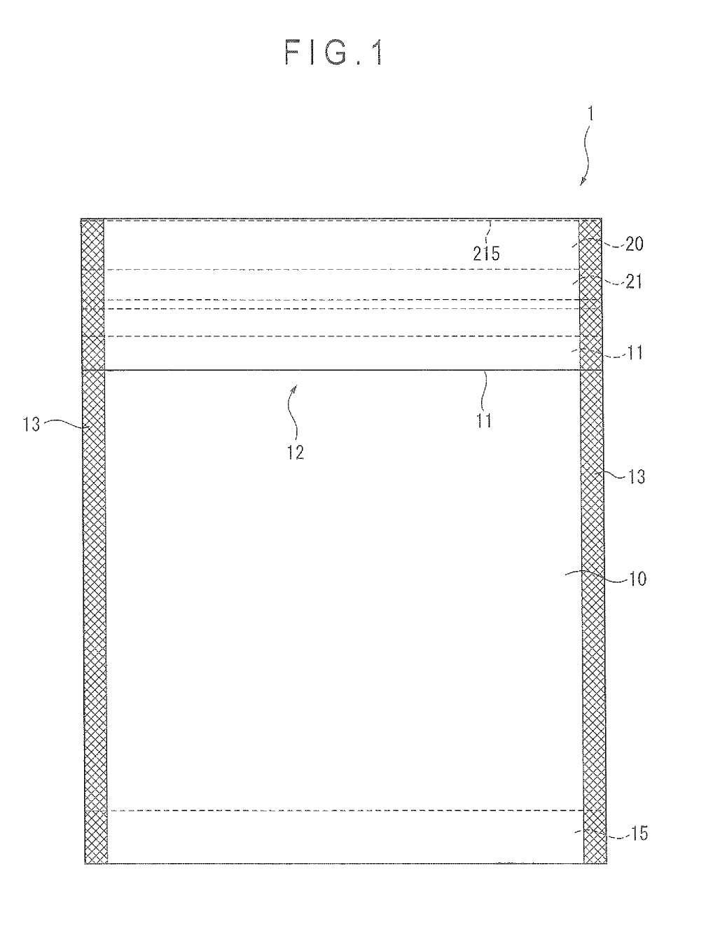

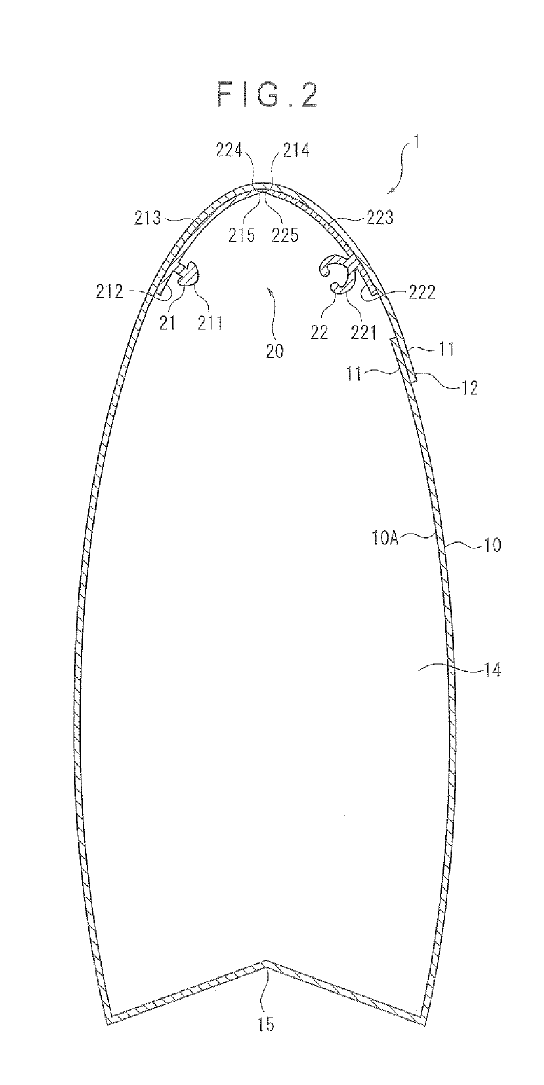

FIG. 1 is a front view showing a packaging bag according to a first exemplary embodiment. FIG. 2 is a cross sectional view showing the packaging bag according to the first exemplary embodiment.

As shown in FIGS. 1 and 2, in a packaging bag 1, a male belt-like member 21 having a male engagement portion 211 and a female belt-like member 22 having a female engagement portion 221 are separately and juxtapositionally bonded to a sheet of base material film 10. The male belt-like member 21 and the female belt-like member 22 provide a zipper tape 20.

The base material film 10 has base material ends 11 and a seal portion 12 provided by layering one of the base material ends 11 to the other thereof. In other words, the base material film 10 is fin-sealed or envelope-sealed.

Side seal portions 13 are provided by heat-sealing both lateral ends of the base material film 10. The male belt-like member 21 and the female belt-like member 22 are provided in such a manner as to stretch between the side seal portions 13.

A containing space 14 is formed by the seal portion 12 and the side seal portions 13 in the base material film 10. The containing space 14 can contain solids such as powders and liquids. A gusset 15 is formed on the bottom of the base material film 10.

The base material film 10 is not particularly limited as long as being a material for a packaging bag. Preferably, a thickness of the base material film 10 is in a range of 10 μm to 200 μm. When the thickness of the base material film 10 is less than 10 μm, sealing strength and bag strength may be weakened. On the other hand, when the thickness of the base material film 10 is more than 200 μm, the bag may be difficult to open.

The base material film 10 may have a single-layered structure or a multi-layered structure.

The base material film 10 has a containing surface 10A facing the containing space 14. The male belt-like member 21 and the female belt-like member 22 are heat-sealed on the containing surface 10A.

The male belt-like member 21 has a male belt-like base 212. The male engagement portion 211 projects from a surface of the male belt-like base 212, the surface facing the containing space 14. The male belt-like base 212 includes an adhesion surface 213 bonded to the base material film 10, a male belt-like base edge 214 substantially abutting on the female belt-like member 22 in a width direction, and a male inclined portion 215 continuously formed from the male belt-like base edge 214.

Likewise, the female belt-like member 22 has a female belt-like base 222. The female engagement portion 221 engageable with the male engagement portion 211 projects from a surface of the female belt-like base 222, the surface facing the containing space 14. The female belt-like base 222 includes an adhesion surface 223 bonded to the base material film 10, a female belt-like base edge 224 substantially abutting on the male belt-like base edge 214 in a width direction, and a female inclined portion 225 continuously formed from the female belt-like base edge 224.

The male belt-like base edge 214 is formed thinner than the male belt-like base 212. The female belt-like base edge 224 is also formed thinner than the female belt-like base 222. A distance from the male engagement portion 211 to the male belt-like base edge 214 is substantially the same as a distance from the female engagement portion 221 to the female belt-like base edge 224.

The male belt-like base edge 214 and the female belt-like base edge 224 provide an engagement positioning unit.

A width of each of the male belt-like base 212 and the female belt-like base 222 is preferably in a range of 2 mm to 50 mm, more preferably in a range of 5 mm to 20 mm.

When the width thereof is less than 2 mm, a holding portion may become small and difficult to hold. On the other hand, when the width thereof is more than 50 mm, a zipper may become larger than a bag to deteriorate balance as a bag.

A thickness of each of the male belt-like base 212 and the female belt-like base 222 is preferably in a range of 50 μm to 500 μm, more preferably in a range of 100 μm to 200 μm.

Materials forming the male belt-like member 21 and the female belt-like member 22 may be the same or different.

Examples of a resin forming the male belt-like member 21 and the female belt-like member 22 may include a copolymer containing an ethylene as a main component such as a random polypropylene (RPP), a low-density polyethylene (LDPE), an ethylene-vinyl acetate copolymer (EVA), an ethylene-methacrylic acid copolymer (EMAA), one of which may be used alone or two or more of which may be used in combination.

Among the above-listed materials forming the male belt-like member 21 and the female belt-like member 22, the random polypropylene (RPP) is preferable for use. By forming the male belt-like member 21 and the female belt-like member 22 from random polypropylene, wrinkle, which is typically generated due to heat shrinkage of the male belt-like member 21 and the female belt-like member 22 when polyethylene is used for forming the base material film 10, can be prevented from being generated on the base material film 10.

Random polypropylene (RPP) used as the male belt-like member 21 and the female belt-like member 22 has a melt flow rate (MFR) preferably in range of 3 g/10 min to 10 g/10 min, particularly preferably in range of 5 g/10 min to 9 g/10 min The MFR of random polypropylene of less than 3 g/10 min may degrade extrusion-moldability of the engagement portions 211 and 221 each of which is formed continuously from and integrally with the male belt-like base 212 and the female belt-like base 222. On the other hand, the MFR exceeding 10 g/10 min may cause tips of hooks of the female engagement portion 221 to be likely to close or may cause the male engagement portion 211 to be likely to tilt down, which may make it difficult to extrude the male belt-like member 21 and the female belt-like member 22 into a predetermined reopenable/resealable shape.

Examples of the base material film 10 may include: a linear low-density polyethylene (LLDPE), a high-density polyethylene (HDPE), a cast polypropylene (CPP), and laminated films laminated by dry laminating or extrusion laminating such as a polyethylene terephthalate (PET)/LLDPE, a PET/CPP, an oriented polypropylene (OPP)/CPP, a nylon/linear low-density polyethylene (LLDPE) and a metal- or an inorganic substance-deposited PET/LLDPE.

An opening position of the packaging bag 1 only has to be closer to an opening (an upper part in FIG. 2) than the engagement portion provided by the male engagement portion 211 and the female engagement portion 221. The packaging bag 1 may become easily openable by providing a notch on the base material film 10 or an opening tape near the male engagement portion 211 and the female engagement portion 221.

In the packaging bag 1 according to the first exemplary embodiment, since the male belt-like base edge 214 and the female belt-like base edge 224 abutting on each other are provided, the base material film 10 is bent between the male belt-like base edge 214 and the female belt-like base edge 224, thereby reliably engaging the male engagement portion 211 with the female engagement portion 221.

### Manufacturing Device of Packaging Bag

Next, a manufacturing device of a packaging bag according to the exemplary embodiment will be described.

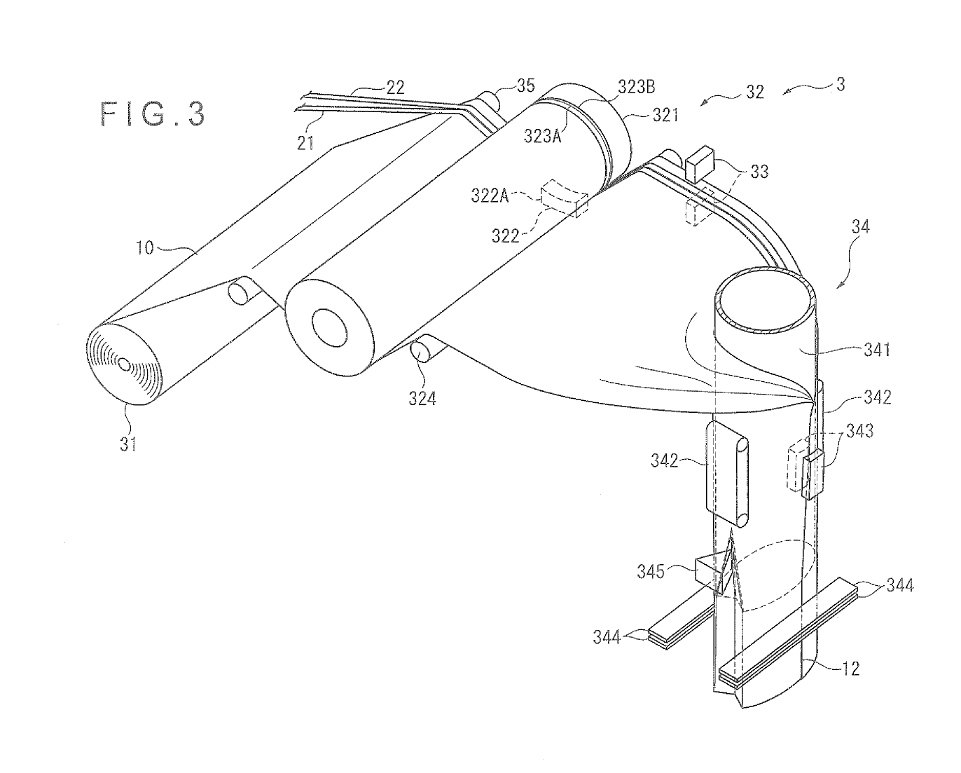

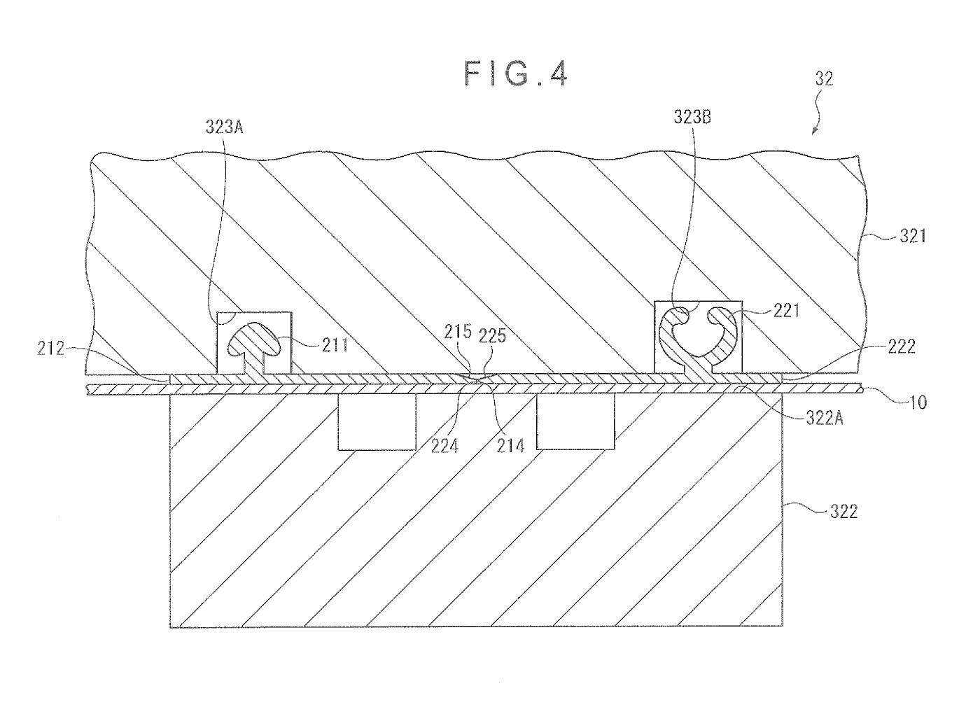

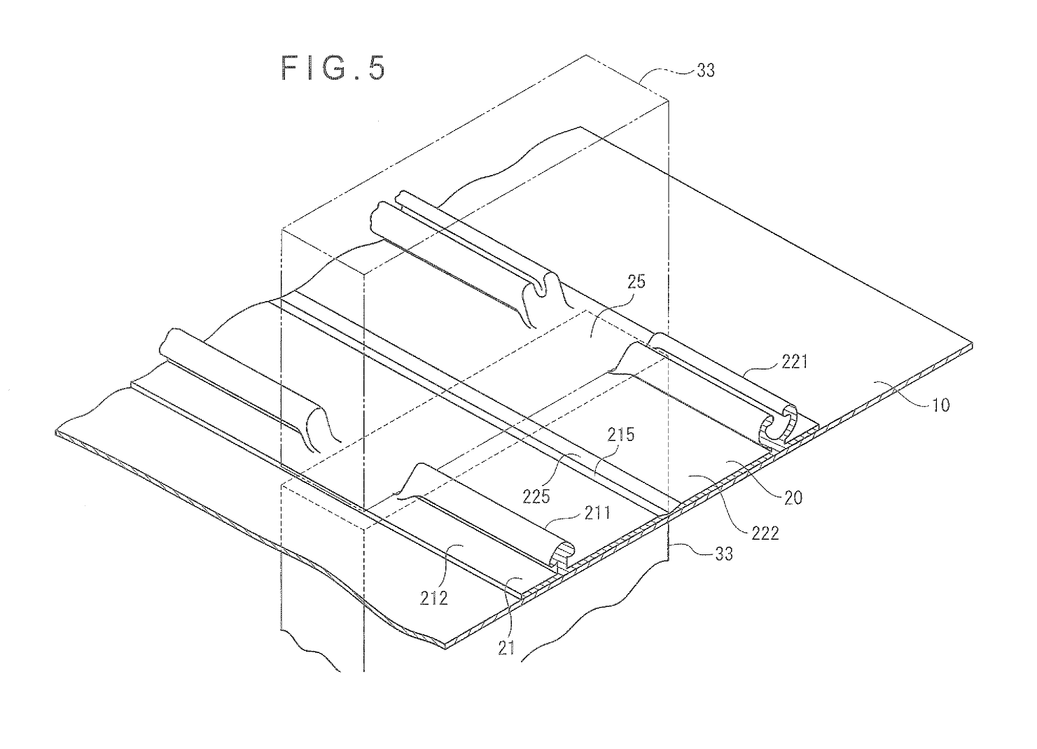

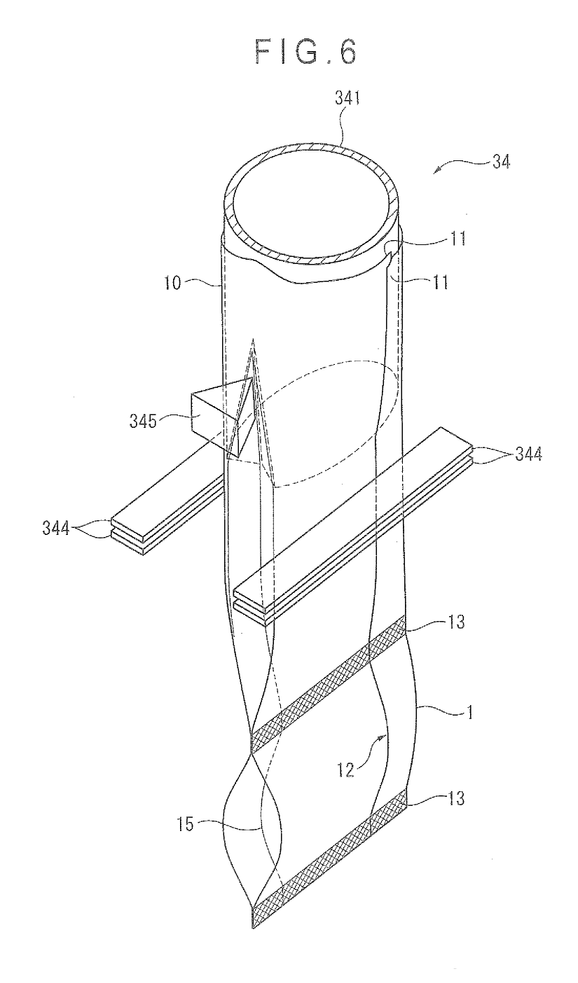

FIG. 3 is a perspective view showing a manufacturing device of a packaging bag. FIG. 4 is a cross-sectional view showing a state where a zipper tape is heat-sealed on a base material film. FIG. 5 is a cross-sectional view showing a state where a male engaging portion and a female engagement portion of the zipper tape are melt-flattened. FIG. 6 is a perspective view showing a state where a gusset is formed in the packaging bag.

As shown in FIG. 3, a manufacturing device 3 includes a tape-winding roller (not shown) that juxtapositionally supplies the male belt-like member 21 and the female belt-like member 22, a film-winding roller 31 that supplies the base material film 10, an adhesion unit 32 that heat-fuses the zipper tape 20 to the base material film 10 supplied by the film-winding roller 31, claw-crushing bars 33 that form a claw-crushed portion 25 at every predetermined interval on the male engagement portion 211 and the female engagement portion 221, and a bag-manufacturing unit 34 that manufactures a bag of the base material film 10 to which the male belt-like member 21 and the female belt-like member 22 each formed with the claw-crushed portion 25 are bonded. A guide roller is numbered as 324.

The single-layered or multilayered base material film 10 made of synthetic resins is wound in a roll around the film-winding roller 31. The base material film 10 pulled out from the film-winding roller 31 is fed to a guide roller 35. After being layered to the male belt-like member 21 and the female belt-like member 22, the base material film 10 is fed to the adhesion unit 32.

As shown in FIGS. 3 and 4, the adhesion unit 32 includes a substantially cylindrical rotary drum 321 that is rotated in conjunction with a film without a driving source, and a seal bar 322 having a heating surface 322A curved to conform with a periphery of the rotary drum 321.

A first groove 323A that introduces the male engagement portion 211, and a second groove 323B that introduces the female engagement portion 221 are provided along a circumferential direction of the rotary drum 321.

The groove 323A has a substantially rectangular cross section large enough to contain the male belt-like member 21. The groove 323B has a substantially rectangular cross section large enough to contain the female belt-like member 22. A bottom surface of each of the grooves 323A and 323B is substantially parallel to the periphery of the rotary drum 321. The opposite lateral surfaces of the groove 323A are formed to have substantially the same length as a projecting length of the male belt-like member 21 and the opposite lateral surfaces of the groove 323B are formed to have substantially the same length as a projecting length of the female belt-like member 22.

The first and second grooves 323A and 323B are provided in a manner capable of introducing the male engagement portion 211 and the female engagement portion 221 therein while the male belt-like base edge 214 and the female belt-like base edge 224 are substantially abutted on each other.

The rotary drum 321 may be supported by a support such that an axial direction of the rotary drum 321 becomes horizontal. With this arrangement, the male belt-like member 21 and the female belt-like member 22 become easily positioned at a predetermined position on the base material film 10.

The rotary drum 321 is preferably provided with a temperature adjusting mechanism for adjusting a temperature of the periphery of the rotary drum 321.

The seal bar 322 is preferably provided with a temperature adjusting mechanism for adjusting a temperature of a surface of the seal bar 322.

The temperature adjusting mechanisms of the rotary drum 321 and the seal bar 322 prevent the zipper tape 20 and the base material film 10 from adhering on the rotary drum 321.

FIG. 5 shows a structure of the zipper tape 20 in which the claw-crushed portion 25 is formed by the claw-crushing bars 33. A pair of claw-crushing bars 33 are opposed to each other with the zipper tape 20 interposed therebetween. The pair of claw-crushing bars 33 crush and melt-flatten the male engagement portion 211 and the female engagement portion 221 at every predetermined interval. The melt-flattened claw-crushed portion 25 is positioned correspondingly to each of the side seal portions 13 of the packaging bag 1.

The bag-manufacturing unit 34 includes a cylinder former 341 around which the base material film 10 fused with the zipper tape 20 is wound, a feed belt 342 disposed on lateral sides of the cylinder former 341, a seal bar 343 that forms the seal portion 12 by fusing both the base material ends 11 of the base material film 10 to each other, a side seal bar 344 that forms the side seal portions 13, and a triangle plate 345 that forms the gusset 15. The cylinder former 341 is formed hollow. The packaging bag 1 is filled with contents through an inner space of the cylinder former 341.

According to the manufacturing device 3 of the first exemplary embodiment, since the male belt-like member 21 and the female belt-like member 22 are bonded to a sheet of base material tape while the male belt-like base edge 214 and the female belt-like base edge 224 are substantially abutted on each other by the first and second grooves 323A and the 323B, the bonding operation can be conducted with accuracy.

### Manufacturing Method of Packaging Bag

Next, a manufacturing method of the packaging bag according to the exemplary embodiment will be described.

The manufacturing method includes: a fusion step of heat-fusing the zipper tape 20 to the base material film 10 by the adhesion unit 32; a claw-crushing step of forming the claw-crushed portion 25 on the male belt-like member 21 and the female belt-like member 22 of the zipper tape 20 by a pair of claw-crushing bars 33 at every predetermined interval; and a bag-manufacturing step of manufacturing a bag from the base material film 10 having the zipper tape 20 on which the claw-crushed portion 25 is formed by the bag-manufacturing unit 34.

The male belt-like member 21 and the female belt-like member 22 pulled out from the tape-winding roller (not shown) are fed to the adhesion unit 32 while being layered to the base film material 10 pulled out from the film-winding roller 31 by the guide roller 35.

As shown in FIG. 4, in the fusion step, the male belt-like member 21, the female belt-like member 22 and the base material film 10 are continuously fed by the rotation of the rotary drum 321 with the male engagement portion 211 and the female engagement portion 221 passing through the grooves 323A and 323B of the rotary drum 321 while the male belt-like member 21 and the female belt-like member 22 are layered to the base material film 10 by the adhesion unit 32. Here, while the male belt-like base edge 214 and the female belt-like base edge 224 are substantially abutted on each other, the male belt-like member 21 and the female belt-like member 22 are fed.

Simultaneously, the male belt-like member 21 and the female belt-like member 22 are bonded to a sheet of base material film 10 by pressing the base material film 10 with the seal bar 322 having the heating surface 322A curved to conform with the periphery of the rotary drum 321, thereby continuously manufacturing the packaging bag 1.

Heat-fusion is continuously conducted on the periphery of the rotary drum 321 by the seal bar 322.

A rotation speed of the rotary drum 321 for continuously feeding the male belt-like member 21, the female belt-like member 22 and the base material film 10 is preferably in a range of 5 m/min to 40 m/min, more preferably in a range of 10 m/min to 30 m/min.

When the speed is less than 5 m/min, productivity may be reduced to increase costs. On the other hand, when the speed exceeds 40 m/min, sealing strength may become unstable.

Thus, the base material film 10 to which the zipper tape 20 is fused is fed to the claw-crushing step without an engagement of the male engagement portion 211 and the female engagement portion 221.

Next, as shown in FIG. 5, the claw-crushing bars 33 form the claw-crushed portions 25 on the male belt-like member 21 and the female belt-like member 22 of the zipper tape 20. The base material film 10 to which the zipper tape 20 is fused is fed to the bag-manufacturing unit 34.

The base material film 10 is fed downward by the feed belt 342 while being wound around the cylinder former 341. Here, the base material film 10 is fed such that the claw-crushed portions 25 and the side seal portions 13 are aligned. While the seal portion 12 is formed by the seal bar 343, the gusset 15 is formed at a position corresponding to the bottom of the bag by the triangle plate 345.

The side seal bar 344 forms one of the side seal portions 13. After the contents are fed through the inner space of the cylinder former 341, the side seal bar 344 forms the other of the side seal portions 13. Subsequently, the packaging bag 1 is provided by cutout.

Here, the zipper tape 20 may include the male engagement portion 211, the female engagement portion 221, and a bent portion. However, with this arrangement, since a width of the zipper tape 20 becomes enlarged, the zipper tape 20 is easily deformed when being wound around the drum. Further, with this arrangement, since the width of the zipper tape 20 is broad, an engagement of the male engagement portion 211 and the female engagement portion 221 may not be conducted with accuracy due to wrinkles generated on the base material film 10 when the zipper tape 20 is bonded to the base material film 10.

### Second Exemplary Embodiment

### Packaging Bag

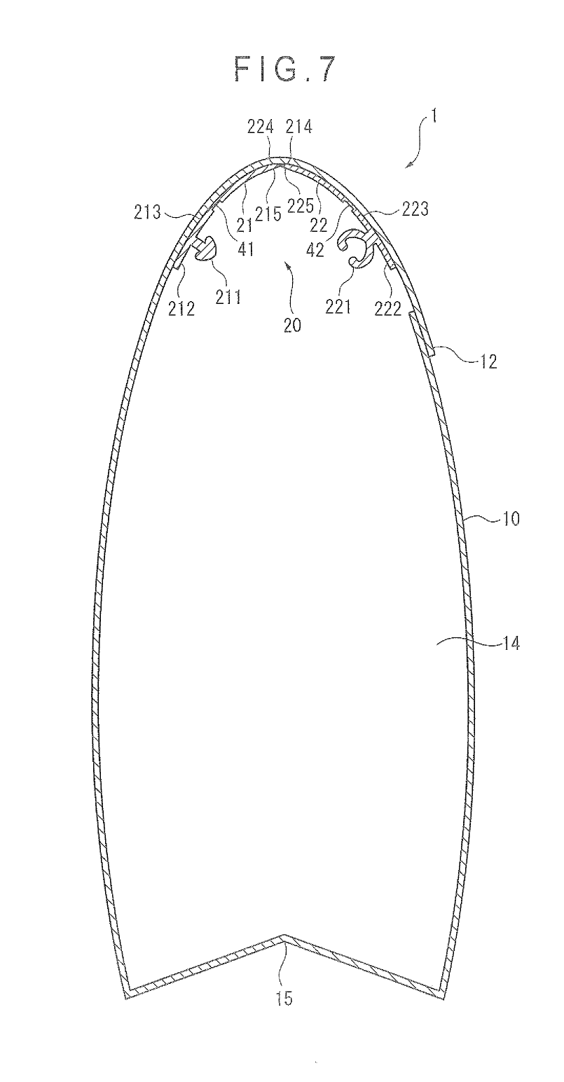

Next, a packaging bag according to a second exemplary embodiment of the invention will be described with reference to FIG. 7.

FIG. 7 is a cross sectional view showing the packaging bag according to the second exemplary embodiment of the invention.

Since the packaging bag according to the second exemplary embodiment is arranged in the same manner as that according to the first exemplary embodiment except for arrangements of a male belt-like member and a female belt-like member, only the male belt-like member and the female belt-like member will be described.

A male-side thin portion 41 and a female-side thin portion 42, which are cuttable, are provided on the male belt-like member 21 and the female belt-like member 22 of the packaging bag 1 according to the second exemplary embodiment. The male-side thin portion 41 and the female-side thin portion 42 are respectively positioned substantially at the same distance from the male belt-like base edge 214 and the female belt-like base edge 224.

Accordingly, in opening the packaging bag 1, the base material film 10 is cut along the male-side thin portion 41 and the female-side thin portion 42 for an easy opening. With this arrangement, a linear cutting becomes possible.

The male-side thin portion 41 and the female-side thin portion 42 may be respectively positioned at different distances from the male belt-like base edge 214 and the female belt-like base edge 224. With this arrangement, a cutting at different levels becomes possible by cutting the base material film 10 along the male-side thin portion 41 and the female-side thin portion 42. By the cutting at different levels, an opening portion is easily held to facilitate opening the bag.

### Third Exemplary Embodiment

### Packaging Bag

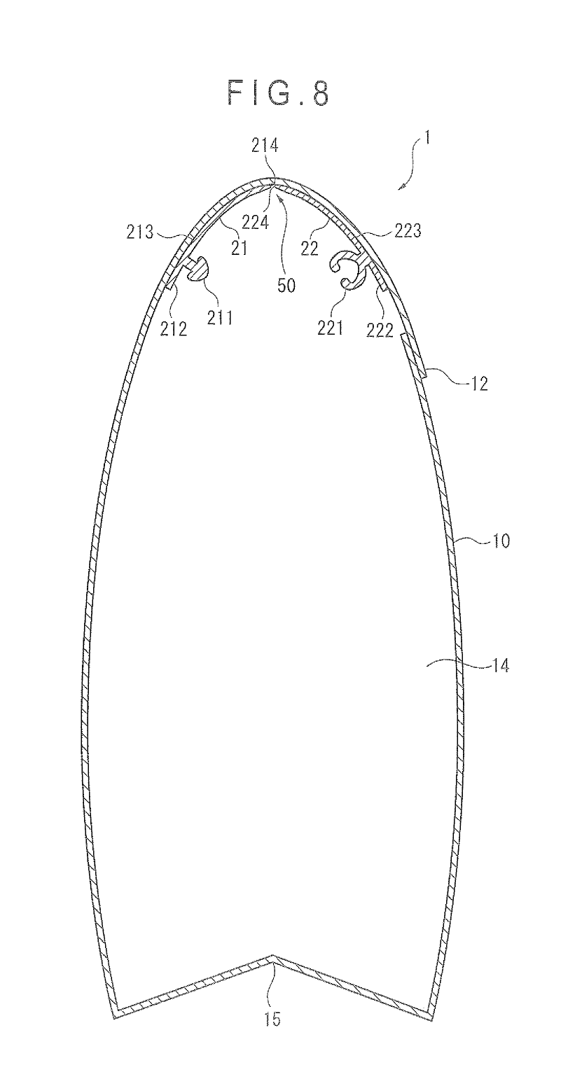

Next, a packaging bag according to a third exemplary embodiment of the invention will be described with reference to FIG. 8.

FIG. 8 is a cross sectional view showing the packaging bag according to the third exemplary embodiment of the invention.

Since the packaging bag according to the third exemplary embodiment is arranged in the same manner as that according to the first exemplary embodiment except for an arrangement of a zipper tape, only the zipper tape will be described.

The packaging bag 1 according to the third exemplary embodiment is provided with a bent space 50 formed between the male belt-like base edge 214 and the female belt-like base edge 224 with a predetermined gap. The bent space 50 is positioned at the same distance from the male engagement portion 211 and the female engagement portion 221.

The bent space 50 provides an engagement positioning unit.

In order to engage the male engagement portion 211 with the female engagement portion 221, the base material film 10 is bent at a position corresponding to the bent space 50, whereby the male engagement portion 211 and the female engagement portion 221 can be reliably engaged with each other.

The gap formed as the bent space 50 is preferably 2 mm or less, more preferably 1 mm or less.

When the gap exceeds 2 mm, an engagement may not be conducted with accuracy.

Moreover, in manufacturing the packaging bag 1, adhesion processing is conducted by the rotary drum 321 and the seal bar 322 while the first and second grooves 323A and the 323B provide a predetermined gap between the male belt-like member 21 and the female belt-like member 22.

A projecting guide portion may be provided between the first and second grooves 323A and the 323B, thereby forming the bent space 50.

### Fourth Exemplary Embodiment

### Packaging Bag

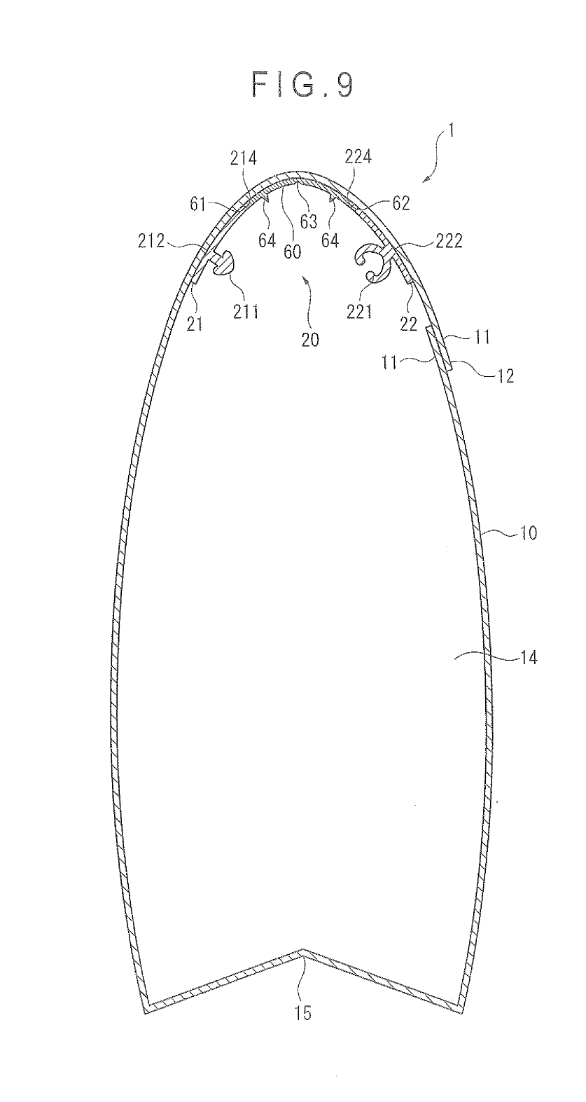

Next, a packaging bag according to a fourth exemplary embodiment of the invention will be described with reference to FIG. 9.

FIG. 9 is a cross sectional view showing the packaging bag according to the fourth exemplary embodiment of the invention.

Since the packaging bag according to the fourth exemplary embodiment is arranged in the same manner as that according to the first exemplary embodiment except for an arrangement of a zipper tape, only the zipper tape will be described.

The zipper tape 20 according to the fourth exemplary embodiment includes the male belt-like base 212, the female belt-like base 222, and a bendable belt-like member 60 deposited between the male belt-like base 212 and the female belt-like base 222.

The bendable belt-like member 60 includes a male-side bent edge 61 that is substantially abutted on the male belt-like base edge 214 of the male belt-like base 212, a female-side bent edge 62 that is substantially abutted on the female belt-like base edge 224 of the female belt-like base 222, and a bent portion 63 substantially centered on the bendable belt-like member 60 in a width direction. The bent portion 63 is positioned at the same distance from the male engagement portion 211 and the female engagement portion 221.

A width of the bendable belt-like member 60 is preferably in a range of 5 mm to 200 mm, more preferably in a range of 6 mm to 30 mm.

When the width thereof is less than 5 mm, the bendable belt-like member 60 may be difficult to bend and hold. On the other hand, when the width thereof is more than 200 mm, tape linearity may be degraded to make an accurate bending of the tape difficult.

A thickness of the bendable belt-like member 60 is preferably in a range of 50 μm to 2 mm, more preferably in a range of 100 μm to 250 μm.

When the thickness thereof is less than 50 μm, the tape is difficult to bend with accuracy. When the thickness thereof exceeds 2 mm, productivity is degraded to increase costs.

The bent portion 63 may be, for instance, a cutout portion or a thin portion.

A cross section of the cutout portion may be a V-shape or U-shape. The cutout portion may be continuously formed along both the longitudinal edges of the bendable belt-like member 60. The cutout portion may be formed in a solid line, a perforated line, or a half-cut line. The cutout portion has a predetermined depth enough to prevent the bendable belt-like member 60 from being separated into two parts even when the bendable belt-like member 60 is bent.

On the other hand, when the bent portion 63 is provided as a thin portion, a thickness of the thin portion is preferably in a range of 20 μm to 120 μm, more preferably in a range of 50 μm to 100 μm. When the thickness of the bent portion 63 is less than 20 μm, the bent portion 63 may be extended or cut when the bent portion 63 is bent. On the other hand, when the thickness of the bent portion 63 exceeds 120 μm, the bent portion 63 may become difficult to bend, thereby hampering an easy engagement of the male engagement portion 211 and the female engagement portion 221.

The bendable belt-like member 60 is also provided with a positioning protrusion 64 that positions the bendable belt-like member 60 on the periphery of the rotary drum 321. When the bendable belt-like member 60 is bonded to the base material film 10 by the adhesion unit 32, the positioning protrusion 64 facilitates positioning the bendable belt-like member 60.

Since the bendable belt-like member 60 substantially abutted on the male belt-like member 21 and the female belt-like member 22 is disposed therebetween, the male belt-like member 21 and the female belt-like member 22 can be accurately positioned on the base material film 10 when bonded.

In addition, since the bendable belt-like member 60 is provided, a width of each of the male belt-like base 212 and the female belt-like base 222 can be reduced. Accordingly, when the male belt-like base 212 and the female belt-like base 222 are bonded to the base material film 10, generation of wrinkles can be prevented as described above.

### Manufacturing Device of Packaging Bag

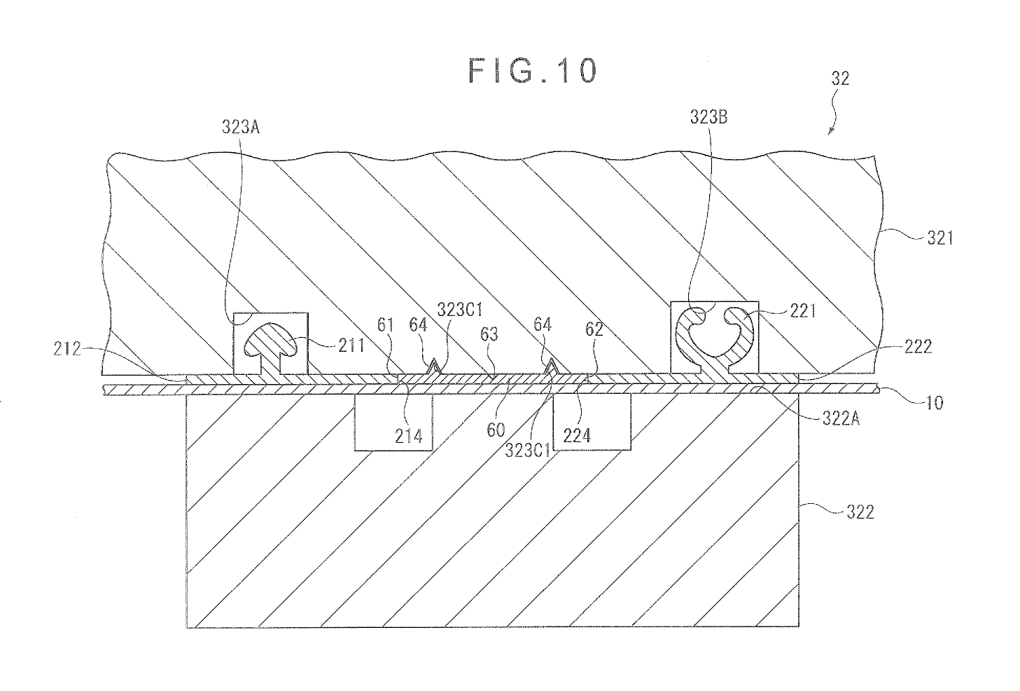

Next, a manufacturing device of the packaging bag according to the fourth exemplary embodiment of the invention will be described with reference to FIG. 10.

FIG. 10 is a cross sectional view showing a state where a zipper tape is heat-sealed to a base material film in a manufacturing method of the packaging bag according to the fourth exemplary embodiment.

Since the manufacturing device 3 according to the fourth exemplary embodiment is arranged in the same manner as that according to the first exemplary embodiment except for an arrangement of a rotary drum, only the rotary drum will be described.

The first and second grooves 323A and 323B of the rotary drum 321 respectively bond the male belt-like member 21 and the female belt-like member 22 to a sheet of base material tape while substantially abutting the male belt-like base edge 214 on the male-side bent edge 61 and substantially abutting the female belt-like base edge 224 on the female-side bent edge 62. Accordingly, the bonding operation can be conducted with accuracy.

A positioning recess 323C1 corresponding to the positioning protrusion 64 of the bendable belt-like member 60 may be provided between the first and second grooves 323A and the 323B.

### Manufacturing Method of Packaging Bag

Next, a manufacturing method of the packaging bag according to the fourth exemplary embodiment of the invention will be described with reference to FIG. 10.

Since the manufacturing method according to the fourth exemplary embodiment is arranged in the same manner as that according to the first exemplary embodiment except for an arrangement of a fusion step, only the fusion step will be described.

As shown in FIG. 10, in the fusion step, the male belt-like member 21, the female belt-like member 22, the bendable belt-like member 60 and the base material film 10 are continuously fed by the rotation of the rotary drum 321 while the male belt-like member 21, the female belt-like member 22 and the bendable belt-like member 60 are layered to the base material film 10 by the rotary drum 321, and the male engagement portion 211, the female engagement portion 221 and the positioning protrusion 64 pass through the grooves 323A and 323B and the positioning recess 323C1 of the rotary drum 321.

Simultaneously, the male belt-like member 21, the female belt-like member 22 and the bendable belt-like member 60 are bonded to a sheet of base material film 10 by pressing the base material film 10 with the seal bar 322 having the heating surface 322A curved to conform with the periphery of the rotary drum 321. With this arrangement, the packaging bag 1 is continuously manufactured.

Thus, the base material film 10 to which the zipper tape 20 is fused is fed to the claw-crushing bars 33 without an engagement of the male belt-like member 21 and the female belt-like member 22.

### Fifth Exemplary Embodiment

### Packaging Bag

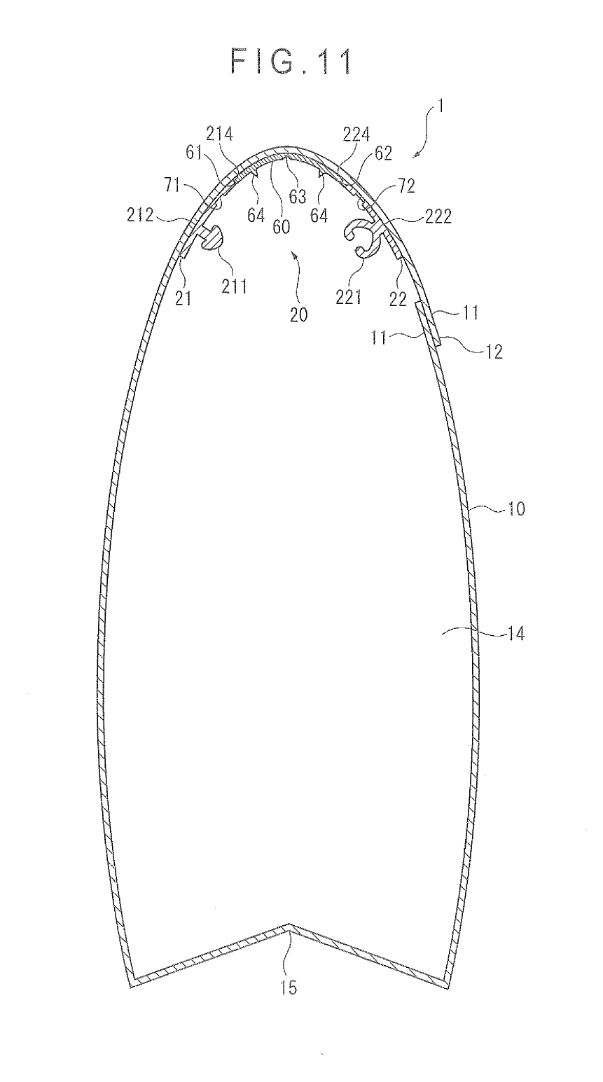

Next, a packaging bag according to a fifth exemplary embodiment of the invention will be described with reference to FIG. 11.

FIG. 11 is a cross sectional view showing the packaging bag according to the fifth exemplary embodiment of the invention.

Since the packaging bag according to the fifth exemplary embodiment is arranged in the same manner as that according to the fourth exemplary embodiment except for arrangements of a male belt-like member and a female belt-like member, only the male belt-like member and the female belt-like member will be described.

The male thin portion 71 and the female thin portion 72, which are cuttable, are respectively provided on the male belt-like member 21 and the female belt-like member 22 of the packaging bag 1 according to the fifth exemplary embodiment in the same manner as those according to the second exemplary embodiment. The male thin portion 71 and the female thin portion 72 are positioned substantially at the same distance from the bent portion 63 of the bendable belt-like member.

In opening the packaging bag 1, the packaging bag 1 can easily be opened along the male thin portion 71 and the female thin portion 72.

### Sixth Exemplary Embodiment

### Arrangement of Packaging Bag

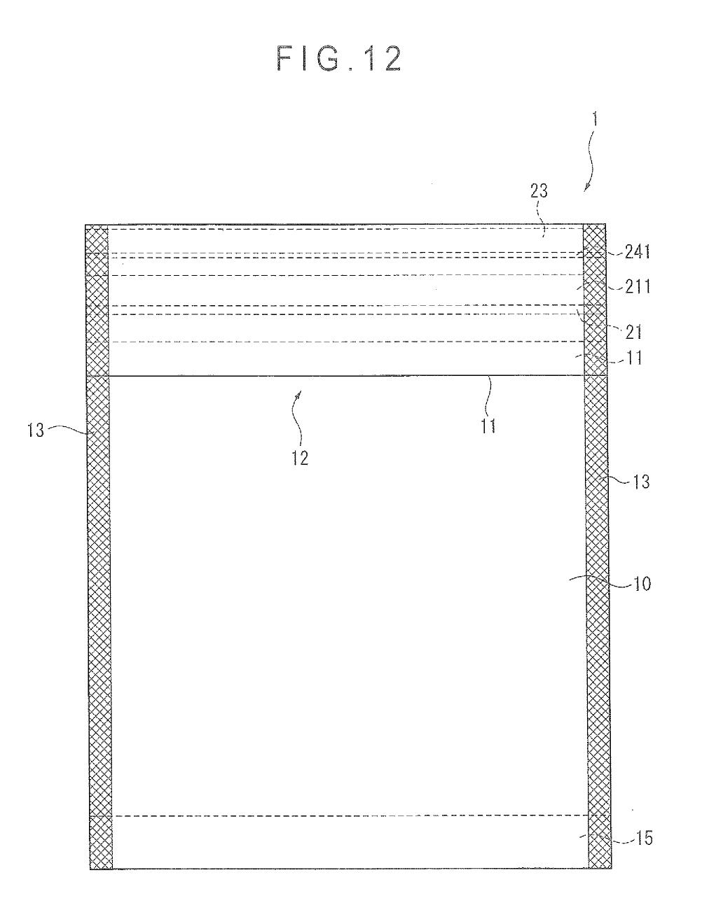

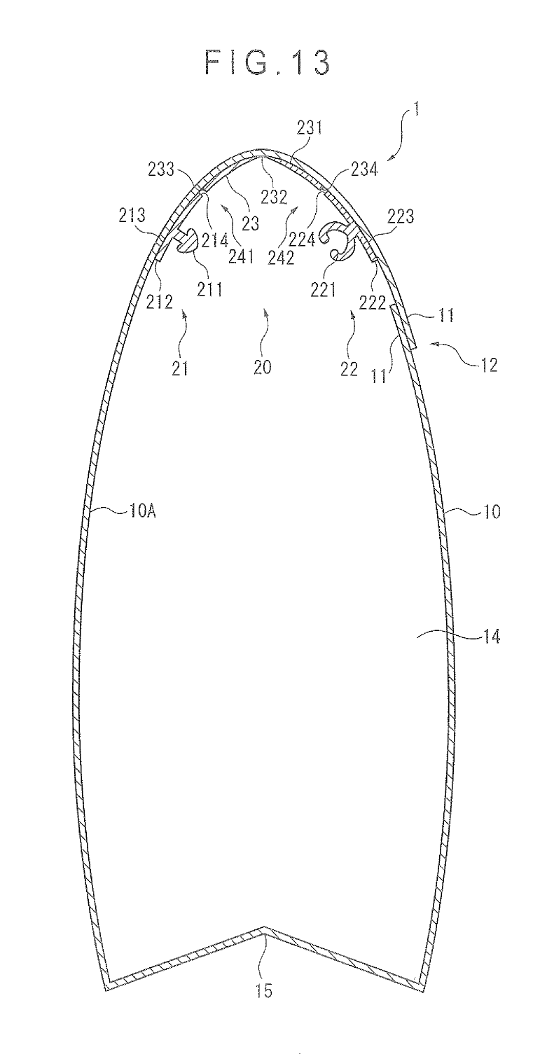

FIG. 12 is a front view showing a packaging bag according to a sixth exemplary embodiment. FIG. 13 is a cross sectional view showing the packaging bag according to the sixth exemplary embodiment.

As shown in FIGS. 12 and 13, in the packaging bag 1, the male belt-like member 21 having the male engagement portion 211, the female belt-like member 22 having the female engagement portion 221, and a bendable belt-like member 23 having a bent portion 232 positioned substantially at the same distance from the male engagement portion 211 and the female engagement portion 221 are separately bonded to a sheet of base material film 10 respectively with a gap 241 between the male belt-like member 21 and the bendable belt-like member 23 and with a gap 242 between the female belt-like member 22 and the bendable belt-like member 23. The male belt-like member 21, the female belt-like member 22 and the bendable belt-like member 23 provide the zipper tape 20.

The base material film 10 has the base material ends 11 and the seal portion 12 provided by layering one of the base material ends 11 to the other thereof. In other words, the base material film 10 is fin-sealed or envelope-sealed.

Side seal portions 13 are provided by heat-sealing both lateral ends of the base material film 10. The male belt-like member 21, the female belt-like member 22 and the bendable belt-like member 23 are provided in such a manner as to stretch between the side seal portions 13.

The containing space 14 is formed by the seal portion 12 and the side seal portions 13 in the base material film 10. The containing space 14 can contain solids and liquids. The gusset 15 is formed on the bottom of the base material film 10.

The base material film 10 has the containing surface 10A facing the containing space 14. The male belt-like member 21, the female belt-like member 22 and the bendable belt-like member 23 are heat-sealed to the containing surface 10A.

The base material film 10 is not particularly limited as long as being a material for a packaging bag. Preferably, a thickness of the base material film 10 is in a range of 10 μm to 200 μm.

When the thickness of the base material film 10 is less than 10 μm, sealing strength and bag strength may be weakened. On the other hand, when the thickness of the base material film 10 is more than 200 μm, the bag may be difficult to open.

The base material film 10 may have a single-layered structure or a multi-layered structure.

The male belt-like member 21 has the male belt-like base 212. The male engagement portion 211 projects from a surface of the male belt-like base 212, the surface facing the containing space 14. The male belt-like base 212 includes the adhesion surface 213 bonded to the base material film 10, and the male belt-like base edge 214 near the bendable belt-like member 23 in a width direction.

The female belt-like member 22 also has the female belt-like base 222. The female engagement portion 221 engageable with the male engagement portion 211 projects from a surface of the female belt-like base 222, the surface facing the containing space 14. The female belt-like base 222 includes the adhesion surface 223 bonded to the base material film 10, and the female belt-like base edge 224 near the bendable belt-like member 23.

A width of each of the male belt-like base 212 and the female belt-like base 222 is preferably in a range of 2 mm to 50 mm, more preferably in a range of 5 mm to 20 mm.

When the width thereof is less than 2 mm, a holding portion may become small and difficult to hold. On the other hand, when the width thereof is more than 50 mm, a zipper may become larger than a bag, resulting in a poor appearance.

A thickness of each of the male belt-like base 212 and the female belt-like base 222 is preferably in a range of 50 μm to 500 μm, more preferably in a range of 100 μm to 200 μm.

The bendable belt-like member 23 includes an adhesion surface 231 bonded to the base material film 10, the bent portion 232 substantially centered on the bendable belt-like member 23 in a width direction, and a male-side bent edge 233 and a female-side bent edge 234 respectively provided with the gaps 241 and 242 from the male belt-like base edge 214 and the female belt-like base edge 224.

The bent portion 232 is formed between one of the side seal portions 13 and the other thereof and substantially in parallel to a longitudinal direction of the male belt-like member 21 and the female belt-like member 22.

A width of the bendable belt-like member 23 is preferably in a range of 5 mm to 200 mm, more preferably in a range of 6 mm to 30 mm.

When the width thereof is less than 5 mm, the bendable belt-like member 23 may be difficult to bend and hold. On the other hand, when the width thereof is more than 200 mm, tape linearity may be degraded to make an accurate bending of the tape difficult.

A thickness of the bendable belt-like member 23 is preferably in a range of 50 μm to 2 mm, more preferably in a range of 100 μm to 250 μm.

When the thickness of the bendable belt-like member 23 is less than 50 μm, an accurate bending may become difficult. On the other hand, when the thickness of the bendable belt-like member 23 is more than 2 mm, productivity may be deteriorated to increase costs.

The bent portion 232 may be, for instance, a cutout portion or a thin portion.

A cross section of the cutout portion may be a V-shape or U-shape. The cutout portion may be continuously formed along both the longitudinal edges of the bendable belt-like member 23. The cutout portion may be formed in a solid line, a perforated line, or a half-cut line. The cutout portion has a predetermined depth enough to prevent the bendable belt-like member 23 from being separated into two parts even when the bendable belt-like member 23 is bent.

On the other hand, when the bent portion 232 is provided as a thin portion, a thickness of the thin portion is preferably in a range of 20 μm to 120 μm, more preferably in a range of 50 μm to 100 μm . When the thickness of the bent portion 232 is less than 20 μm , the bent portion 232 may be extended or cut when the bent portion 232 is bent. On the other hand, when the thickness of the bent portion 232 exceeds 120 μm , the bent portion 232 may become difficult to bend, thereby hampering an easy engagement of the male engagement portion 211 and the female engagement portion 221.

The gap 241 between the male belt-like base edge 214 and the male-side bent edge 233 and the gap 242 between the female belt-like base edge 224 and the female-side bent edge 234 are each preferably in a range of 0.5 mm to 30 mm, more preferably in a range of 0.5 mm to 10 mm When the gaps 241 and 242 are each less than 0.5 mm or more than 30 mm, cutting performance becomes poor.

Materials forming the male belt-like member 21, the female belt-like member 22 and the bendable belt-like member 23 may be the same or different.

Examples of a resin forming the male belt-like member 21, the female belt-like member 22 and the bendable belt-like member 23 may include a copolymer containing an ethylene as a main component such as a random polypropylene (RPP), a low-density polyethylene (LDPE), an ethylene-vinyl acetate copolymer (EVA), an ethylene-methacrylic acid copolymer (EMAA), one of which may be used alone or two or more of which may be used in combination.

Among the above-listed materials forming the male belt-like member 21, the female belt-like member 22 and the bendable belt-like member 23, the random polypropylene (RPP) is preferable for use. By forming the male belt-like member 21, the female belt-like member 22 and the bendable belt-like member 23 from the random polypropylene, wrinkle, which is typically generated due to heat shrinkage of the male belt-like member 21, the female belt-like member 22 and the bendable belt-like member 23 when polyethylene is used for forming the base material film 10, can be prevented from being generated on the base material film 10.

Random polypropylene (RPP) used as the male belt-like member 21, the female belt-like member 22 and the bendable belt-like member 23 has a melt flow rate (MFR) preferably in range of 3 g/10 min to 10 g/10 min, particularly preferably in range of 5 g/10 min to 9 g/10 min. The MFR of random polypropylene of less than 3 g/10 min may degrade extrusion-moldability of the male belt-like member 21, the female belt-like member 22, and the bendable belt-like member 23. On the other hand, the MFR exceeding 10 g/10 min may cause tips of hooks of the female engagement portion 221 to be likely to close or may cause the male engagement portion 211 to be likely to tilt down, which may make it difficult to extrude the male belt-like member 21 and the female belt-like member 22 into a predetermined reopenable/resealable shape.

Examples of the base material film 10 may include: a linear low-density polyethylene (LLDPE), a high-density polyethylene (HDPE), a cast polypropylene (CPP), and laminated films laminated by dry laminating or extrusion laminating such as a polyethylene terephthalate (PET)/LLDPE, a PET/CPP, an oriented polypropylene (OPP)/CPP, a nylon/linear low-density polyethylene (LLDPE) and a metal- or an inorganic substance-deposited PET/LLDPE.

In the packaging bag 1 according to the sixth exemplary embodiment, since the bendable belt-like member 23 having the bent portion 232 is provided substantially at the same distance from the male belt-like member 21 and the female belt-like member 22 therebetween, the male engagement portion 211 and the female engagement portion 221 can be reliably engaged with each other by bending the bent portion 232.

Moreover, since the bent portion 232 is substantially centered on the bendable belt-like member 23, when the bent portion 232 is bent, the gap 241 between the male belt-like member 21 and the bendable belt-like member 23 is at substantially the same level as the gap 242 between the female belt-like member 22 and the bendable belt-like member 23. With this arrangement, in opening the packaging bag 1, the base material film 10 can be cut along the gaps 241 and 242. In other words, a linear cutting becomes possible. Accordingly, an easy opening becomes possible without a separate cutting mechanism.

### Manufacturing Device of Packaging Bag

Next, a manufacturing device of the bag according to the exemplary embodiment will be described.

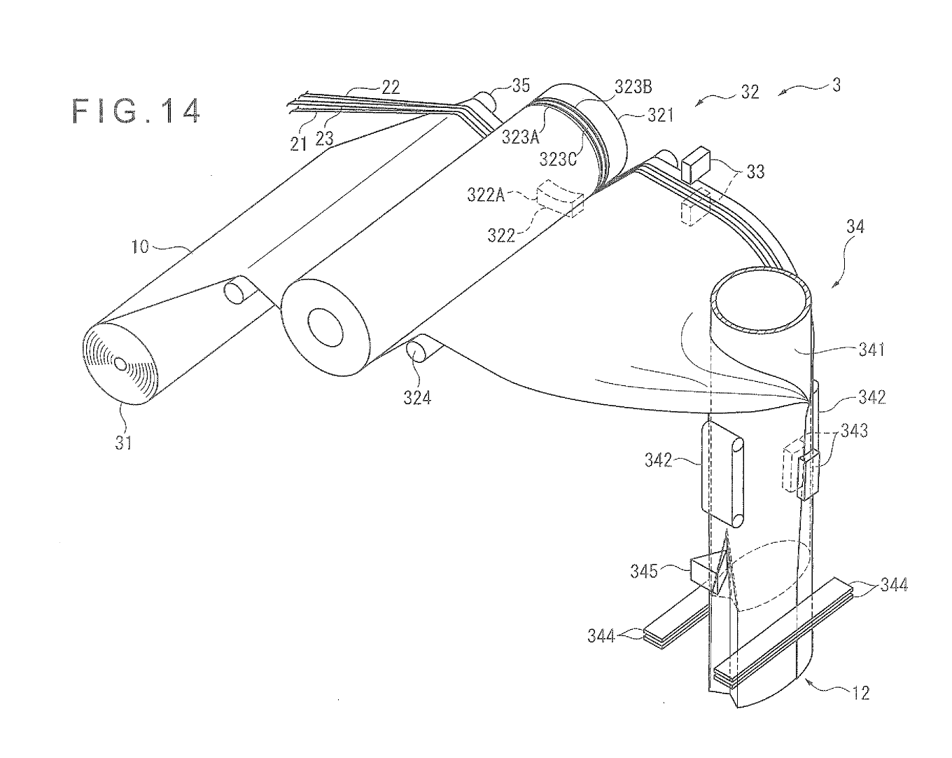

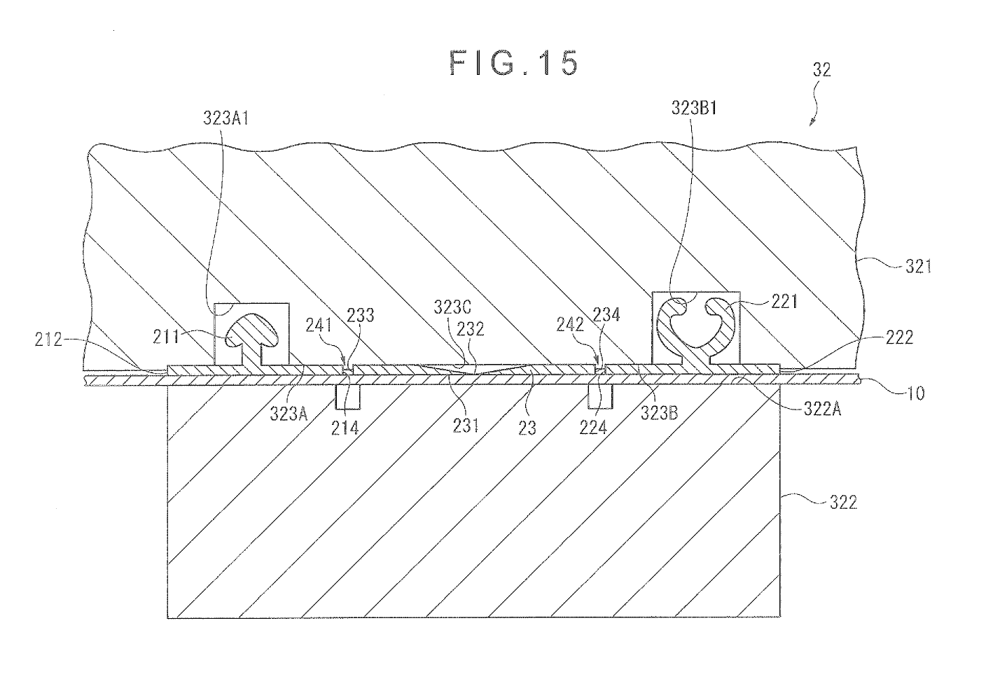

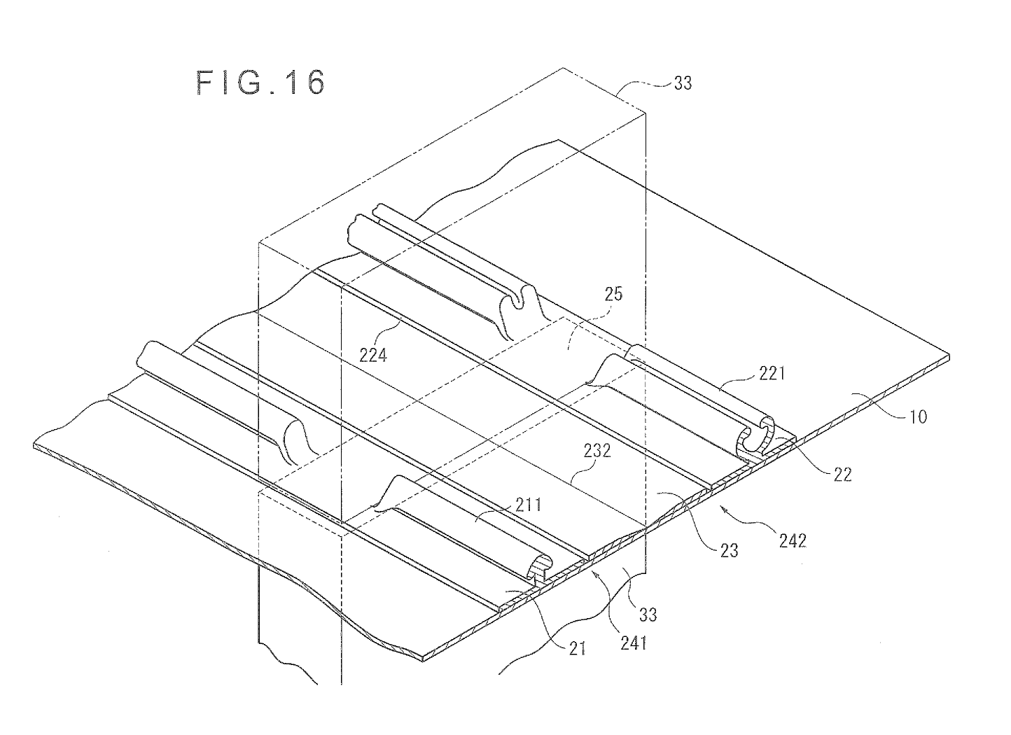

FIG. 14 is a perspective view showing a manufacturing device of a packaging bag. FIG. 15 is a cross-sectional view showing a state where a zipper tape is heat-sealed to a base material film. FIG. 16 is a cross-sectional view showing a state where a male engaging portion and a female engagement portion of the zipper tape are melt-flattened. FIG. 6 is a perspective view showing a state where a gusset is formed in the packaging bag.

As shown in FIG. 14, the manufacturing device 3 includes the tape-winding roller (not shown) that supplies the male belt-like member 21, the female belt-like member 22 and the bendable belt-like member 23, the film-winding roller 31 that supplies the base material film 10, the adhesion unit 32 that heat-fuses the zipper tape 20 with the base material film 10 supplied by the film-winding roller 31, the claw-crushing bars 33 that form the claw-crushed portion 25 at every predetermined interval on the male belt-like member 21 and the female belt-like member 22, the bag-manufacturing unit 34 that manufactures a bag of the base material film 10 to which the male belt-like member 21 and the female belt-like member 22 each formed with the claw-crushed portion 25 are bonded. A guide roller is numbered as 324.

The single-layered or multilayered base material film 10 made of synthetic resins is wound in a roll on the film-winding roller 31. The base material film 10 pulled out from the film-winding roller 31 is fed to the guide roller 35. After being layered to the male belt-like member 21, the female belt-like member 22 and the bendable belt-like member 23, the base material film 10 is fed to the adhesion unit 32.

As shown in FIGS. 14 and 15, the adhesion unit 32 includes the substantially cylindrical rotary drum 321 that is rotated in conjunction with a film without a driving source, and the seal bar 322 having a heating surface 322A curved to conform with a circumferential shape of the rotary drum 321.

The first groove 323A that introduces the male belt-like base 212, the second groove 323B that introduces the female belt-like base 222, and a third groove 323C that introduces the bendable belt-like member 23 are each provided in the rotary drum 321 along a circumferential direction. A male introduction groove 323A1 that introduces the male engagement portion 211 is provided substantially at the center of the first groove 323A. A female introduction groove 323B1 that introduces the female engagement portion 221 is provided substantially at the center of the first groove 323B.

The third groove 323C is provided between the first groove 323A and the second groove 323B in an axial direction of the rotary drum 321. The groove 323A has a depth enough to substantially contain the male belt-like base 212 in a thickness direction thereof. The groove 323B has a depth enough to substantially contain the female belt-like base 222 in a thickness direction thereof. The groove 323C has a depth enough to substantially contain the bent belt-like base 23 in a thickness direction thereof. The groove 323A may have any shape and size as long as the groove 323A can substantially contain the male engagement portion 211 in a thickness direction thereof. The groove 323B may have any shape and size as long as the groove 323B can substantially contain the female engagement portion 221 in a thickness direction thereof. The groove 323C may have any shape and size as long as the groove 323C can substantially contain the bendable belt-like member 23 in a thickness direction thereof.

In this exemplary embodiment, the groove 323A has a substantially rectangular cross section large enough to substantially contain the male belt-like base 212 in a thickness direction thereof. The groove 323B has a substantially rectangular cross section large enough to substantially contain the female belt-like base 222 in a thickness direction thereof. The groove 323C has a substantially rectangular cross section large enough to substantially contain the bendable belt-like member 23 in a thickness direction thereof. A bottom surface of each of the grooves 323A, 323B and 323C is substantially parallel to the periphery of the rotary drum 321. A depth thereof is formed to be shallower than the thickness of the male belt-like base 212 and the female belt-like base 222.

The male introduction groove 323A1 and the female introduction groove 323B1 have substantially rectangular cross sections large enough to contain the male engagement portion 211 and the female engagement portion 221 respectively. A bottom surface of each of the male introduction groove 323A1 and the female introduction groove 323B1 is substantially parallel to the periphery of the rotary drum 321. A depth thereof is formed to be deeper than a projection length of each of the male engagement portion 211 and the female engagement portion 221.

The rotary drum 321 may be supported by a support such that an axial direction of the rotary drum 321 becomes horizontal. With this arrangement, the male belt-like member 21, the female belt-like member 22 and the bendable belt-like member 23 become easily positioned at a predetermined position on the base material film 10.

The rotary drum 321 may be provided with a drum temperature adjusting mechanism capable of adjusting a temperature of the periphery of the rotary drum 321 to a temperature (e.g., 20 to 50 degrees C.) where the base material film 10 is not bonded.

The seal bar 322 is provided with a seal temperature adjusting mechanism for adjusting a temperature of the heating surface 322A.

The drum temperature adjusting mechanism of the rotary drum 321 and the seal temperature adjusting mechanism of the seal bar 322 prevent the zipper tape 20 from adhering on the rotary drum 321.

FIG. 16 shows a structure of the zipper tape 20 in which the claw-crushed portion 25 is formed by the claw-crushing bars 33. A pair of claw-crushing bars 33 are opposed to each other with the zipper tape 20 interposed therebetween. The pair of claw-crushing bars 33 crush and melt-flatten the male engagement portion 211 and the female engagement portion 221 at every predetermined distance. The melt-flattened claw-crushed portion 25 is positioned correspondingly to the side seal portion 13 of the packaging bag 1.

As shown in FIGS. 14 and 6, the bag-manufacturing unit 34 includes the cylindrical former 341 around which the base material film 10 fused with the zipper tape 20 is wound, the feed belt 342 disposed on lateral sides of the cylinder former 341, the seal bar 343 that forms the seal portion 12 by fusing the both base material ends 11 of the base material film 10, the side seal bar 344 that forms the side seal portions 13, and the triangle plate 345 that forms the gusset 15. The cylinder former 341 is formed hollow. The packaging bag 1 is filled with contents through an inner space of the cylindrical former 341.

In the manufacturing device 3 according to the sixth exemplary embodiment, since the first, second and third grooves 323A, 323B and 323C are provided, the male belt-like member 21, the female belt-like member 22 and the bendable belt-like member 23 can be accurately bonded to a sheet of base material film 10 with the gaps 241 and 242 therebetween.

### Manufacturing Method of Packaging Bag

Next, a manufacturing method of the bag according to the exemplary embodiment will be described.

The manufacturing method includes: an adhesion step of heat-fusing the zipper tape 20 on the base material film 10 by the adhesion unit 32; a claw-crushing step of forming the claw-crushed portion 25 on the male belt-like member 21 and the female belt-like member 22 of the zipper tape 20 by a pair of claw-crushing bar 33 at every predetermined interval; and a bag-manufacturing step of manufacturing a bag from the base material film 10 having the zipper tape 20 on which the claw-crushed portion 25 is formed by the bag-manufacturing unit 34.

The male belt-like member 21, the female belt-like member 22 and the bendable belt-like member 23 pulled out from the tape-winding roller (not shown) are fed to the adhesion unit 32 while being layered to the base film material 10 pulled out from the film-winding roller 31 by the guide roller 35.

As shown in FIG. 15, in the adhesion step, the male belt-like member 21, the female belt-like member 22 and the bendable belt-like member 23 are continuously fed by the rotation of the rotary drum 321 while the male belt-like member 21, the female belt-like member 22 and the bendable belt-like member 23 are layered to the base material film 10 by the adhesion unit 32 and the male belt-like base 212, the female belt-like base 222 and the bendable belt-like member 23 pass through the grooves 323A, 323B and 323C of the rotary drum 321.

Simultaneously, the packaging bag 1 is continuously manufactured by bonding the male belt-like member 21, the female belt-like member 22 and the bendable belt-like member 23 to a sheet of base material film 10 by pressing the base material film 10 with the seal bar 322 having the heating surface 322A curved to conform with the periphery of the rotary drum 321.

Heat-fusion is continuously conducted on the periphery of the rotary drum 321 by the seal bar 322.

A speed of a continuous feeding by the rotation of the rotary drum 321 is preferably in a range of 5 m/min to 40 m/min, more preferably in a range of 10 m/min to 30 m/min.

When the speed is less than 5 m/min, productivity may be reduced to increase costs. On the other hand, when the speed exceeds 40 m/min, sealing strength may become unstable.

Thus, the base material film 10 to which the zipper tape 20 is fused is fed to the claw-crushing bars 33 without an engagement of the male belt-like member 21 and the female belt-like member 22.

Next, as shown in FIG. 16, the claw-crushing bars 33 form the claw-crushed portion 25 on the male belt-like member 21 and the female belt-like member 22 of the zipper tape 20. The base material film 10 to which the zipper tape 20 is fused is fed to the bag-manufacturing unit 34.

The base material film 10 is fed downward by the feed belt 342 while being wound around the cylindrical former 341. Here, the base material film 10 is fed such that the claw-crushed portion 25 and the side seal portion 13 are aligned. While the seal portion 12 is formed by the seal bar 343, the gusset 15 is formed at a position corresponding to the bottom of the bag by the triangle plate 345.

The side seal bar 344 forms one of the side seal portions 13. After the contents are fed through the inner space of the cylinder former 341, the side seal bar 344 forms the other of the side seal portions 13. Subsequently, the packaging bag 1 is provided by cut-out.

Here, the zipper tape 20 may include the male engagement portion 211, the female engagement portion 221, and the bent portion 232. However, with this arrangement, since a width of the zipper tape 20 becomes enlarged, the zipper tape 20 is easily deformed when being wound around the drum. Further, with this arrangement, since the width of the zipper tape 20 is large, an engagement of the male engagement portion 211 and the female engagement portion 221 may not be conducted with accuracy due to wrinkles generated on the base material film 10 when the zipper tape 20 is adhered on the base material film 10.

### Seventh Exemplary Embodiment

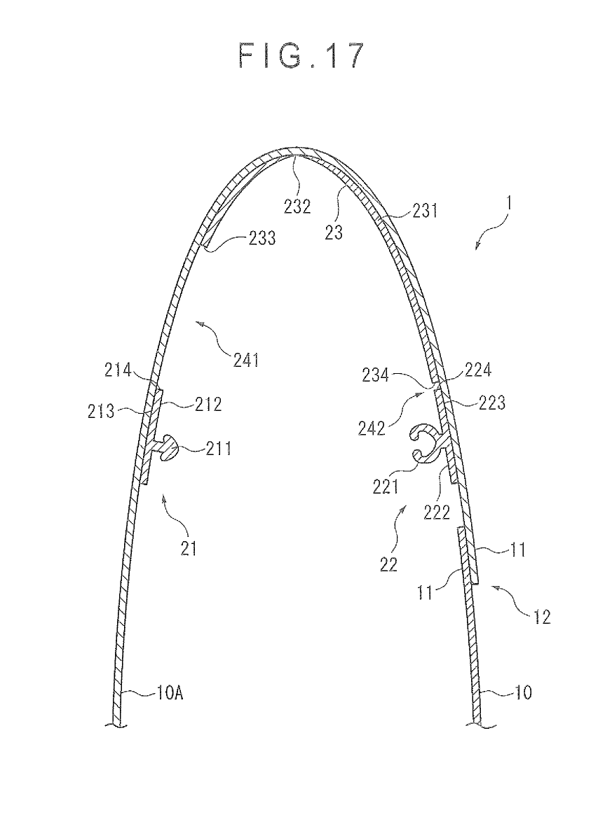

Next, a seventh exemplary embodiment of the invention will be described with reference to FIG. 17.

FIG. 17 is a cross sectional view showing the packaging bag according to the seventh exemplary embodiment of the invention.

Since the packaging bag according to the seventh exemplary embodiment is arranged in the same manner as that according to sixth exemplary embodiment except for an arrangement of a zipper tape, only the zipper tape will be described.

In the seventh exemplary embodiment, the gap 241 is larger than the gap 242. Specifically, a distance from the male-side bent edge 233 to the male belt-like base edge 214 is longer than a distance from the female-side bent edge 234 to the female belt-like base edge 224.

The bent portion 232 is provided close to the male-side bent edge 233 from substantially the center in a width direction.

A distance from the bent portion 232 to the male engagement portion 211 is substantially the same as a distance from the bent portion 232 to the female engagement portion 221.

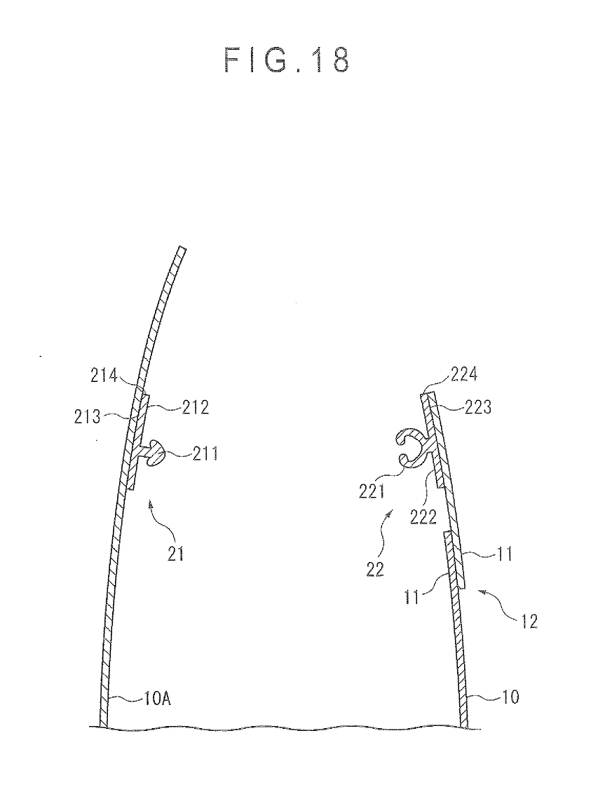

In opening the packaging bag 1, when the base material film 10 is cut along the gap 241 near the male-side bent edge 233 and along the gap 242, a cutting at different levels becomes possible, so that opening points are at different levels as shown in FIG. 18. Since the opening points are at different levels, an opening portion of the packaging bag 1 becomes easy to hold, thereby facilitating opening.

A size of the gap 241 is preferably in a range of 3 mm to 30 mm. A size of the gap 242 is preferably in a range of 0.5 mm to 10 mm.

In this exemplary embodiment, a case where the gap 241 is provided larger than the gap 242 is described. However, an arrangement of the gaps 241 and 242 is not limited to this. The gap 242 may be provided larger than the gap 241.

The scope of the invention is not limited to the above-described embodiments but also includes modifications and improvements as long as an object of the invention can be achieved.

For instance, a sheet of belt-like member provided with the both of the male engagement portion 211 and the female engagement portion 221 is prepared. This belt-like member is cut at the center in a width direction before being wound around the rotary drum 321 to form the male belt-like member 21 having the male engagement portion 211 and the female belt-like member 22 having the female engagement portion 221. Subsequently, the male belt-like member 21 and the female belt-like member 22 may be introduced to the grooves of the rotary drum 321.

Further, in the manufacturing methods according to the fourth and fifth exemplary embodiments, the male engagement portion 211 and the female engagement portion 221 may be introduced to the first and second grooves 323A and 323B formed along a circumferential direction of the rotary drum 321 while the bendable belt-like member 60 is provided between the male belt-like member 21 and the female belt-like member 22 and spaced from the male belt-like base edge 214 and the female belt-like base edge 224 with a predetermined gap.

With this arrangement, the bendable belt-like member 60 can be spaced from the male belt-like base edge 214 and the female belt-like base edge 224 with a predetermined gap without providing a groove for introducing the bendable belt-like member 60.

In the fourth exemplary embodiment, the bent portion 63 is positioned at the same distance from the male engagement portion 211 and the female engagement portion 221. However, the bent portion 63 may be positioned near the male belt-like base edge 214 or the female belt-like base edge 224.

In the packaging bag 1 provided with such a bendable belt-like member 60, the male belt-like base edge 214 is positioned in a different level from that of the female belt-like base edge 224. Accordingly, when the bag is cut along the male belt-like base edge 214 and the female belt-like base edge 224, a cutting at different levels becomes possible.

In the manufacturing device 3 according to the above exemplary embodiment(s), a nip pressure controller for controlling linear pressure applied between the rotary drum 321 and the seal bar 322 may be further provided. With this nip pressure controller, the male belt-like member 21, the female belt-like member 22 and the bendable belt-like member 60 or 23, which are introduced into between the rotary drum 321 and the seal bar 322, can be deposited at a predetermined position on the base material film 10 with higher accuracy.

A contact distance controller for controlling a contact distance at which the male belt-like member 21, the female belt-like member 22 and the bendable belt-like member 60 or 23 are brought into contact with the periphery of the rotary drum 321 may be further provided. With this contact distance controller, in the same manner as with the nip pressure controller, the male belt-like member 21, the female belt-like member 22 and the bendable belt-like member 60 or 23 can be deposited at a predetermined position on the base material film 10 with higher accuracy.

Further, positioning protrusions 64 and 40 may be provided in the male belt-like member 21 and the female belt-like member 22.

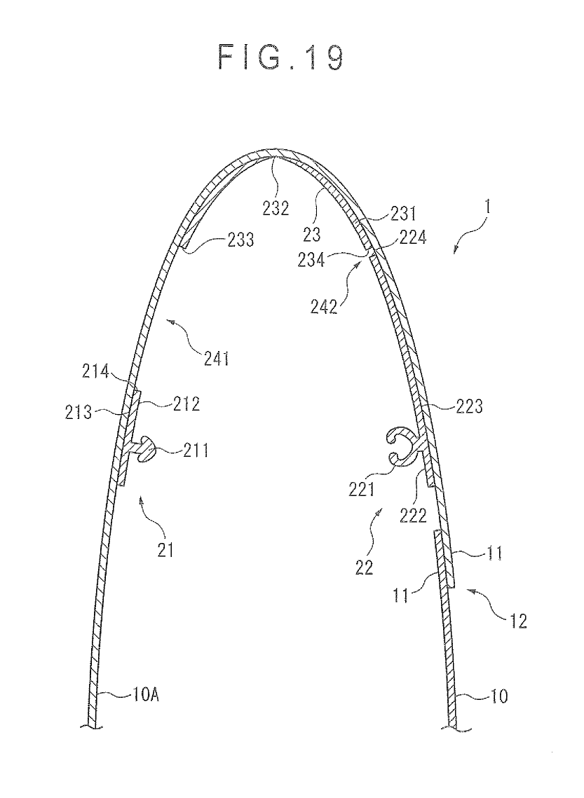

As shown in FIG. 19, a cutting at different levels may be provided by differentiating the gap 241 between the male-side bent edge 233 and the male belt-like base edge 214 from the gap 242 between the female-side bent edge 234 and the female belt-like base edge 224 by using the bendable belt-like member 23 of the sixth exemplary embodiment.

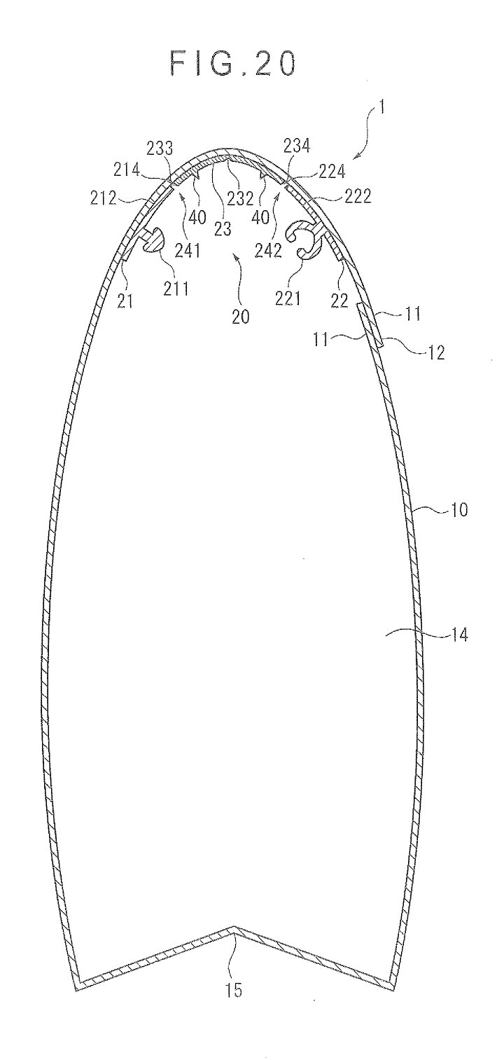

Further, as shown in FIG. 20, in the bendable belt-like member 23, the positioning protrusions 40 for positioning the bendable belt-like member 23 on the periphery of the rotary drum 231 may be respectively provided between the bent portion 232 and the male-side bent edge 233 and between the bent portion 232 and the female-side bent edge 234. With this arrangement, when the bendable belt-like member 23 is bonded to the base material film 10 by the adhesion unit 32, the positioning protrusions 40 facilitate positioning the bendable belt-like member 23.

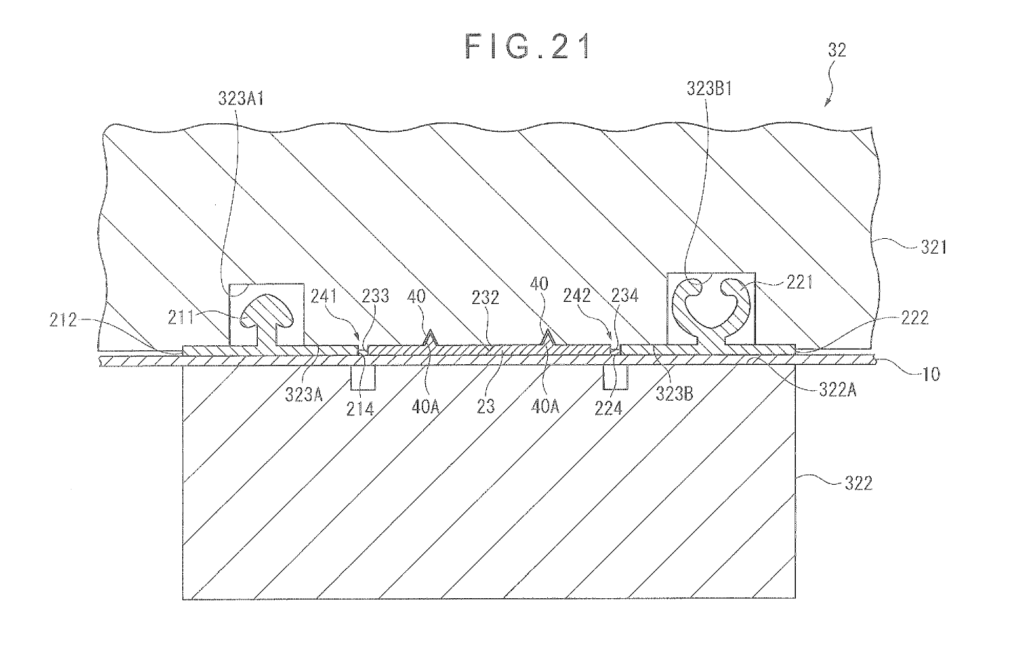

As shown in FIG. 21, in manufacturing the packaging bag 1 as shown in FIG. 20, positioning recesses 40A corresponding to the positioning protrusions 40 of the bendable belt-like member 23 may be provided in the third groove 323C.

This arrangement can reliably provide a predetermined gap between the bendable belt-like member 23 and the male belt-like base edge 214 and a predetermined gap between the bendable belt-like member 23 and the female belt-like base edge 224.

1. A packaging bag with a zipper tape, comprising:
a male belt-like member having a male engagement portion;
a female belt-like member having a female engagement portion;
a sheet of base material film on which the male belt-like member and the female belt-like member are provided; and
an engagement positioning unit that enables the male engagement portion and the female engagement portion to be engaged with each other when the base material film is bent, the engagement positioning unit being positioned substantially at the same distance from the male engagement portion and the female engagement portion.

2. The packaging bag with the zipper tape according to claim 1, wherein the engagement positioning unit is provided with a male-side abutment portion and a female-side abutment portion respectively in the male belt-like member and the female belt-like member, the male-side abutment portion and the female-side abutment portion substantially abutting on each other at ends thereof in a width direction.

3. The packaging bag with the zipper tape according to claim 1, wherein
the engagement positioning unit is a bendable belt-like member that is provided between the male belt-like member and the female belt-like member and that comprises a bent portion that enables the base material film to be bent, the bent portion positioned substantially at the same distance from the male engagement portion and the female engagement portion.

4. The packaging bag with the zipper tape according to claim 1, wherein
the male belt-like member has a cuttable male thin portion, and
the female belt-like member has a cuttable female thin portion.

5. The packaging bag with the zipper tape according to claim 4, wherein
the male thin portion and the female thin portion are positioned at different distances from the engagement positioning unit.

6. (canceled)

7. (canceled)

8. (canceled)

9. (canceled)

10. (canceled)

11. The packaging bag with the zipper tape according to claim 3, wherein
the bendable belt-like member has a width of 5 mm to 200 mm.

12. The packaging bag with the zipper tape according to claim 1, wherein
each of the male belt-like member and the female belt-like member has a width of 2 mm to 50 mm.

13. A manufacturing device of a packaging bag with a zipper tape, the packaging bag comprising: a male belt-like member having a male engagement portion; a female belt-like member having a female engagement portion; and a sheet of base material film on which the male belt-like member and the female belt-like member are provided, the manufacturing device comprising:
a substantially cylindrical rotary drum provided with a first groove that introduces the male engagement portion and a second groove that introduces the female engagement portion, the first and second groove being provided along a circumferential direction of the rotary drum; and
a seal bar having a temperature adjusting mechanism on a heating surface curved to conform with a periphery of the rotary drum, wherein
the first and second grooves are allowed to respectively introduce the male engagement portion and the female engagement portion while the male belt-like member and the female belt-like member are substantially abutted on each other at ends thereof in a width direction.

14. The manufacturing device of the packaging bag with the zipper tape according to claim 13, wherein
the first and second grooves are allowed to respectively introduce the male engagement portion and the female engagement portion while a bendable belt-like member that enables the male engagement portion and the female engagement portion to be engaged with each other is provided between the male belt-like member and the female belt-like member and is substantially abutted thereon.

15. (canceled)

16. (canceled)

17. (canceled)

18. (canceled)

19. (canceled)

20. A bendable belt-like member enabling a base material film to be bent for engaging a male engagement portion with a female engagement portion provided on a sheet of base material tape, the bendable belt-like member comprising:
a bent portion centered on the bendable belt-like member in a width direction thereof; and
an adhesion surface to which the base material tape is to be bonded.

21. A bendable belt-like member enabling a base material film to be bent for engaging a male engagement portion with a female engagement portion provided on a sheet of base material tape, the bendable belt-like member comprising:
a bent portion provided close to either edge of the bendable belt-like member from the center thereof in a width direction, and
an adhesion surface to which the base material tape is to be bonded.

22. The bendable belt-like member according to claims 20,
wherein the bent portion is a cutout portion or a thin portion.

23. The bendable belt-like member according to claim 21, wherein the bent portion is a cutout portion or a thin portion.
